(19) United States
(12) Patent Application Publication
(10) Pub. No.: US 2007/0236418 A1
(43) Pub. Date: Oct. 11, 2007

(54) Field Emission Display

(76) Inventor: Nongqiang Fan, Issaquah, WA (US)

Correspondence Address: NONGQIANG FAN, PO BOX 377, ISSAQUAH, WA, 98027, US

(21) Appl. No.: 11/763,447

(22) Filed: Jun. 15, 2007

Related U.S. Application Data
(63) Continuation-in-part of application No. 11/164,595, filed on Nov. 30, 2005.

(51) Int. Cl. G09G 3/22; H01J 1/70

(52) U.S. Cl. 345/75.2; 313/495

(57) ABSTRACT

A faceplate for using in a filed emission display includes an array of conducting sheets, a biasing conducting electrode, an array of load resistors, an array of contacting electrodes, and an array of coupling elements on a substantially transparent plate. A load resistor is electrically connected between the biasing conducting electrode and one conducting sheet. A coupling element is electrically connected between one contacting electrode and one conducting sheet.

### RELATED APPLICATIONS

This application is a Continuation-In-Part application of U.S. application Ser. No. 11/164,595, filed on Nov. 30, 2005, titled “method of driving field emission display,” which are hereby incorporated herein by reference.

### BACKGROUND

The present invention relates generally to field emission displays.

FIG. 1 shows a section of a field emission display that includes a matrix of electron-emitting elements (e.g., 150AA, 150AB, 150AC, 150BA, 150BB, 150BC, 150CA, 150CB, and 150CC). The field emission display also includes an array of selection lines (e.g., 120A, 120B, and 120C) and an array of data driving lines (e.g., 140A, 140B, and 140C). In the field emission display, an electron-emitting element can be electrically connected to at least one selection line and at least one data driving line. For example, in FIG. 1, electron-emitting element 150BB is electrically connected to selection line 120B and data driving line 140B.

In the field emission display, a selection line (e.g., 120B) can be electrically connected to a selection driver (e.g., 125B), and a data driving line (e.g., 140B) can be electrically connected to a data driver (e.g., 145B).

FIG. 1 shows that a field emission display also includes an anode plate 200. A filed emission display generally also includes an enclosure (not shown in the figure) for maintaining substantially vacuum space between the matrix of the electron-emitting elements and anode plate 200. The anode is coated with phosphors. When a row of electron-emitting elements is selected for emitting electrons, the electron-emitting elements in the selected row (e.g., 150BA, 150BB, and 150BC) can emit electrons toward anode plate 200. When electrons strike the anode, light will be emitted from phosphors on anode plate 200. The intensity of the light emitted generally depends on several factors, such as, the energy of the electrons striking the anode plate, the amount of the electrons striking the anode plate, and the optical properties of the phosphors. In operation, after one row of electron-emitting elements is selected for emitting electrons and for generating a corresponding row of light pixels on the anode plate, next row of electron-emitting elements is selected for emitting electrons and for generating another row of light pixels on the anode plate. When all rows of electron-emitting elements are selected one by one sequentially, a display image can be formed on the anode plate.

The amounts of electrons emitted from a given electron-emitting element in the selected row generally depend on a data signal (such as a voltage data signal or a current data signal) applied to that given electron-emitting element through a data driving line. For example, the amounts of electrons emitted from electron-emitting element 150BB generally depends on a data signal on data driving line 140B; the amounts of electrons emitted from electron-emitting element 150BC generally depends on a data signal on data driving line 140C. Ideally, if the data signal on data driving line 140B is the same as the data signal on data driving line 140C, the amounts of electrons emitted from electron-emitting element 150BB should be almost the same as the amounts of electrons emitted from electron-emitting element 150BC. Unfortunately, in a real display device, the amounts of electrons emitted from electron-emitting element 150BB may be different from the amounts of electrons emitted from electron-emitting element 150BC, because the properties of electron-emitting element 150BB may be different from the properties of electron-emitting element 150BC. The difference in properties generally is due to the difficulty in maintaining uniform properties among large number of electron-emitting elements manufactured across a display device.

Because the amounts of electrons emitted from a given electron-emitting element depend on the individual properties of that given electron-emitting element, the image formed on a display device may not be very uniform. Therefore, it is desirable to find certain technologies that may provide better method to control the amount of electrons emitted from each electron-emitting element.

### SUMMARY

In one aspect, a display device includes an array of selection lines, an array of data driving lines crossing the array of selection lines, an array of anodes being substantially parallel to the array of data driving lines, a matrix of electron-emitting elements, and an array of data drivers. The display device also includes an enclosure configured to maintain substantially vacuum space between the matrix of the electron-emitting elements and the array of anodes. In the display device, an anode in the array of anodes has phosphors thereon. An electron-emitting element in the matrix of the electron-emitting element is electrically connected to at least one selection line and at least one data driving line. A data driver receives at least one sensing signal from at least one anode in the array of anodes and is electrically connected to at least one data driving line in the array of data driving lines.

Implementations of the display device can include one or more of the following features. An anode can be configured to receive electrons from a corresponding column of electron-emitting elements chosen from the matrix of electron-emitting elements. An anode can be configured to receive electrons from a corresponding plurality of columns of electron-emitting elements chosen from the matrix of electron-emitting elements. In the matrix of electron-emitting elements, a column of electron-emitting elements can be configured to emit electrons to a corresponding anode in the array of anodes. In the matrix of electron-emitting elements, a column of electron-emitting elements can be configured to emit electrons to a corresponding plurality of anodes in the array of anodes. In the display device, an electron-emitting element can include a cold cathode, a nano-tube cathode, a nano-particle cathode, a Spindt cathode, or a surface conduction cathode. The monitoring device can include a current monitor or a charge monitor. The monitoring device can include an amplifier configured to measure a voltage across a sensing resistor. An anode in the array of anodes can include a column of electrically connected anode segments.

Implementations of the display device can also include one or more of the following features. In the display device, a data driver can be configured to receive a sensing signal from an anode and transmits a data signal to a data driving line. The display devices can include a plurality of monitoring devices. A monitoring device can be electrically connected to at least one anode in the array of anodes. A monitoring device can include a current monitor or a charge monitor. A monitoring device can include an amplifier configured to measure a voltage across a sensing resistor. In the display device, a data driver can be configured to receive at least one sensing signal from at least one monitoring device in the plurality of monitoring devices.

In another aspect, a display device includes an array of selection lines, an array of data driving lines crossing the array of selection lines, an array of anodes being substantially parallel to the array of data driving lines, a matrix of electron-emitting elements, a plurality of monitoring devices, and an array of data drivers. The display device also includes an enclosure configured to maintain substantially vacuum space between the matrix of the electron-emitting elements and the array of anodes. In the display device, an electron-emitting element is electrically connected to at least one selection line and at least one data driving line. In the display device, a monitoring device is electrically connected to at least one anode in the array of anodes. A data driver is electrically connected to at least one monitoring device in the plurality of monitoring devices and is electrically connected to at least one data driving line in the array of data driving lines.

Implementations of the display device can include one or more of the following features. In the display device, a data driver can be configured to receive at least one sensing signal from at least one monitoring device chosen from the plurality of monitoring devices. A data driver can be configured to receive at least one sensing signal from at least one anode in the array of anodes and generates at least one data signal on at least one data driving line in the array of data driving lines. A data driving line can be electrically connected to at least one data driver that receives at least one sensing signal from at least one anode in the array of anodes.

In another aspect, a method is applied on a display device. The display device includes a matrix of electron-emitting elements, an array of selection lines, an array of data driving lines crossing the array of selection lines, an array of anodes being substantially parallel to the array of data driving lines, and an enclosure configured to maintain substantially vacuum space between the matrix of the electron-emitting elements and the array of anodes. The method of driving the display device includes selecting a row of electron-emitting elements from the matrix of electron-emitting elements for emitting electrons. The method of driving also includes receiving electrons emitted from a given electron-emitting element in the selected row with a given anode chosen from the array of anodes. The method of driving still includes driving the given electron-emitting element with a data driver that receives a sensing signal from the given anode. The driving includes transmitting at least one data signal from the data driver to at least one data driving line that is electrically connected to the given electron-emitting element.

In another aspect, a method is applied on a display device. The display device includes a matrix of electron-emitting elements, an array of selection lines, an array of data driving lines crossing the array of selection lines, an array of anodes being substantially parallel to the array of data driving lines, and an enclosure configured to maintain substantially vacuum space between the matrix of the electron-emitting elements and the array of anodes. The method of driving the display device includes selecting multiple electron-emitting elements from the matrix of electron-emitting elements for emitting electrons. For each given electron-emitting element chosen from the multiple electron-emitting elements, the method also includes driving the given electron-emitting element with a data driver that receives a sensing signal from a given anode that receives electrons emitted from the given electron-emitting element. The driving includes transmitting at least one data signal from the data driver to at least one data driving line that is electrically connected to the given electron-emitting element.

In another aspect, a method is applied on a display device. The display device includes a matrix of electron-emitting elements, an array of selection lines, an array of data driving lines crossing the array of selection lines, an array of anodes being substantially parallel to the array of data driving lines, and an enclosure configured to maintain substantially vacuum space between the matrix of the electron-emitting elements and the array of anodes. The method of driving the display device includes selecting multiple electron-emitting elements from the matrix of electron-emitting elements for emitting electrons. For each given electron-emitting element chosen from the multiple electron-emitting elements, the method also includes driving the given electron-emitting element with at least one data signal that depends upon a sensing signal from a given anode that receives electrons emitted from the given electron-emitting element. The receiving of electrons by the given anode affects the sensing signal.

In another aspect, a faceplate for using in a filed emission display device includes a substantially transparent plate. On the substantially transparent plate, the faceplate further includes an array of conducting sheets, a biasing conducting electrode, an array of load resistors, an array of contacting electrodes, and an array of coupling elements. A conducting sheet has phosphors thereon. A load resistor is electrically connected between the biasing conducting electrode and one conducting sheet. A coupling element is electrically connected between one contacting electrode and one conducting sheet.

On the substantially transparent plate, the faceplate can further include an array of interfacing electrodes. An interfacing electrode and a contacting electrode is electrically connected. The array of interfacing electrodes can be configured for Tape Automated Bonding.

On the substantially transparent plate, the faceplate can further include a common conducting electrode and an array of sensing elements. A sensing element is electrically connected between one contacting electrode and the common conducting electrode.

Implementations of the faceplate can include one or more of the following features. A coupling element can be a coupling resistor, a coupling capacitor, or any combination thereof. A conducting sheet can includes a plurality of conducting segments. A sensing element can be a sensing resistor, a sensing capacitor, or any combination thereof. A conducting sheet can includes a plurality of conducting segments.

In another aspect, a faceplate for using in a filed emission display device includes a substantially transparent plate. On the substantially transparent plate, the faceplate further includes an array of conducting sheets, a biasing conducting electrode, an array of resistors, and an array of interfacing electrodes. A conducting sheet has phosphors thereon. A resistor is electrically connected between the biasing conducting electrode and one conducting sheet. An interfacing electrode and a conducting sheet is electrically connected. In one implementation, the array of interfacing electrodes can be configured for Tape Automated Bonding.

### BRIEF DESCRIPTION OF THE DRAWINGS

The present invention will be understood more fully from the detailed description and accompanying drawings of the invention set forth herein. However, the drawings are not to be construed as limiting the invention to the specific embodiments shown and described herein. Like reference numbers are designated in the various drawings to indicate like elements.

FIG. 1 shows a section of a field emission display that includes a matrix of electron-emitting elements.

FIG. 2 shows a display device that includes an array of anodes.

FIG. 3A shows a display device that includes an array of anodes formed on a faceplate and a matrix of electron-emitting elements formed on a substrate.

FIG. 3B shows that an electron-emitting element includes a lateral cold cathode.

FIG. 3C-FIG. 3D each shows that an electron-emitting element includes a vertical cold cathode.

FIG. 4A-FIG. 4B each shows a specific implementation of the monitoring devices.

FIG. 5A-FIG. 5E each show a display device that includes a plurality of monitoring devices electrically connected to an array of anodes.

FIG. 6A-FIG. 6E arid FIG. 7A-FIG. 7E each show a display device that includes data drivers receiving signals from monitoring devices.

FIG. 8A-FIG. 8B each shows an exemplary implementation of the data driver.

FIG. 9A-FIG. 9E each shows an exemplary implementation of the monitoring device.

FIG. 10 and FIG. 11 each show a method of driving a display device having a plurality of anodes.

FIG. 12 shows a display device that includes an array of anodes in which an anode includes multiple electrically connected anode segments.

FIG. 13 shows a display device that includes an array of anodes in which an anode is configured to receive electrons from multiple corresponding columns of electron-emitting elements.

FIG. 14 shows a display device including a column of electron-emitting elements that is configured to emit electrons to multiple corresponding anodes in an array of anodes.

FIG. 15 shows an implementation of a monitoring device that is associated with multiple corresponding anodes.

FIG. 16 shows an implementation of a faceplate structure that includes an array of coupling resistors.

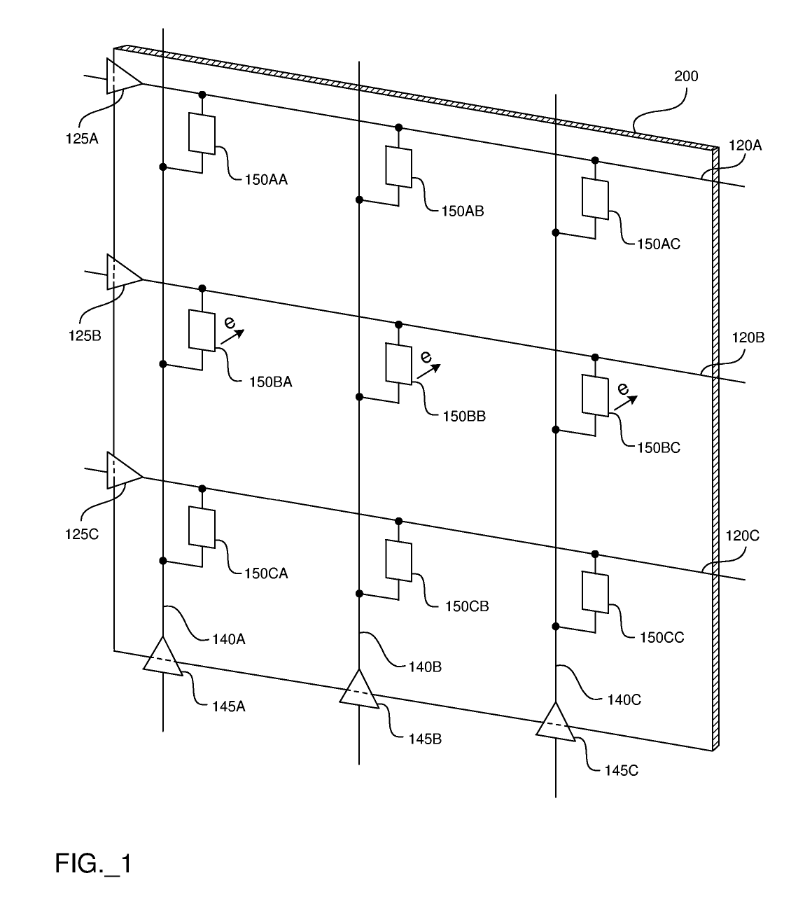

### DETAILED DESCRIPTION

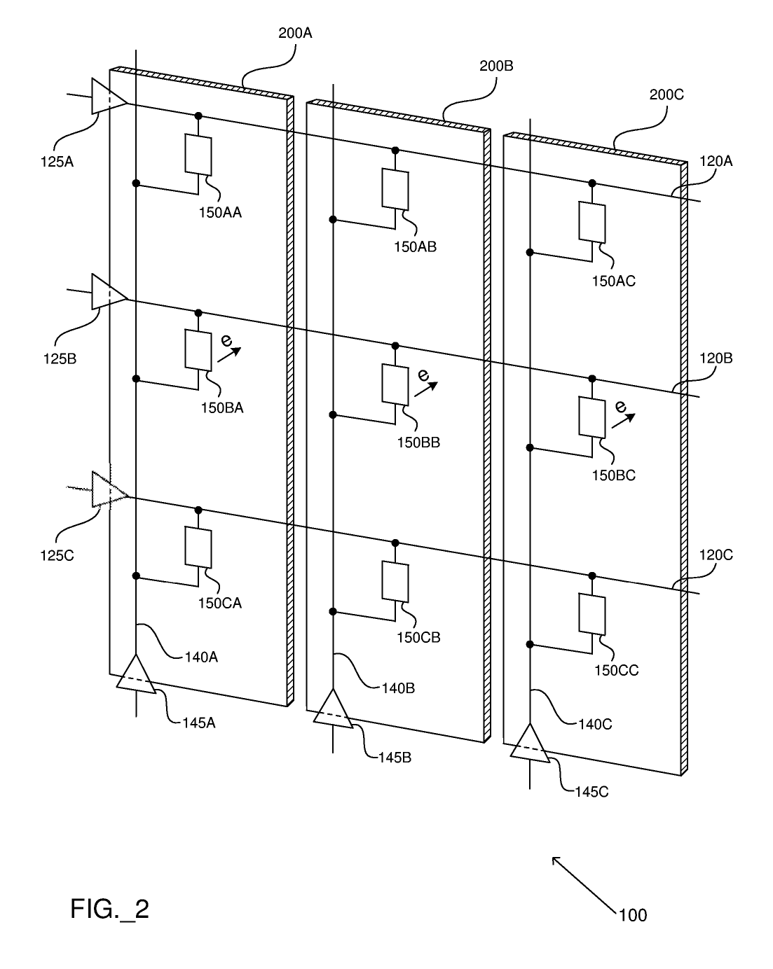

FIG. 2 shows a display device that includes an array of anodes. The display device includes an array of selection lines (e.g., 120A, 120B, and 120C), an array of data driving lines (e.g., 140A, 140B, and 140C), an array of anodes (e.g., 200A, 200B, and 200C), a matrix of electron-emitting elements (e.g., 150AA, 150AB, . . . , and 150CC) and an enclosure (not shown in the figure) configured to maintain substantially vacuum space between the matrix of the electron-emitting elements and the array of anodes. The array of data driving lines (e.g., 140A, 140B, and 140C) crosses the array of selection lines (e.g., 120A, 120B, and 120C). The array of anodes (e.g., 200A, 200B, and 200C) is substantially parallel to the array of data driving lines (e.g., 140A, 140B, and 140C). An electron-emitting element is electrically connected to at least one selection line and at least one data driving line. For example, electron-emitting element 150BB is electrically connected to selection line 120B and data driving line 140B.

In the implementation as shown in FIG. 2, an electron-emitting element can include a cold cathode. An electron-emitting element can include a surface conduction cathode, a nano-tube cathode, a nano-particle cathode, or a Spindt cathode. An electron-emitting element in the display device can include a cold cathode diode, or a cold cathode triode.

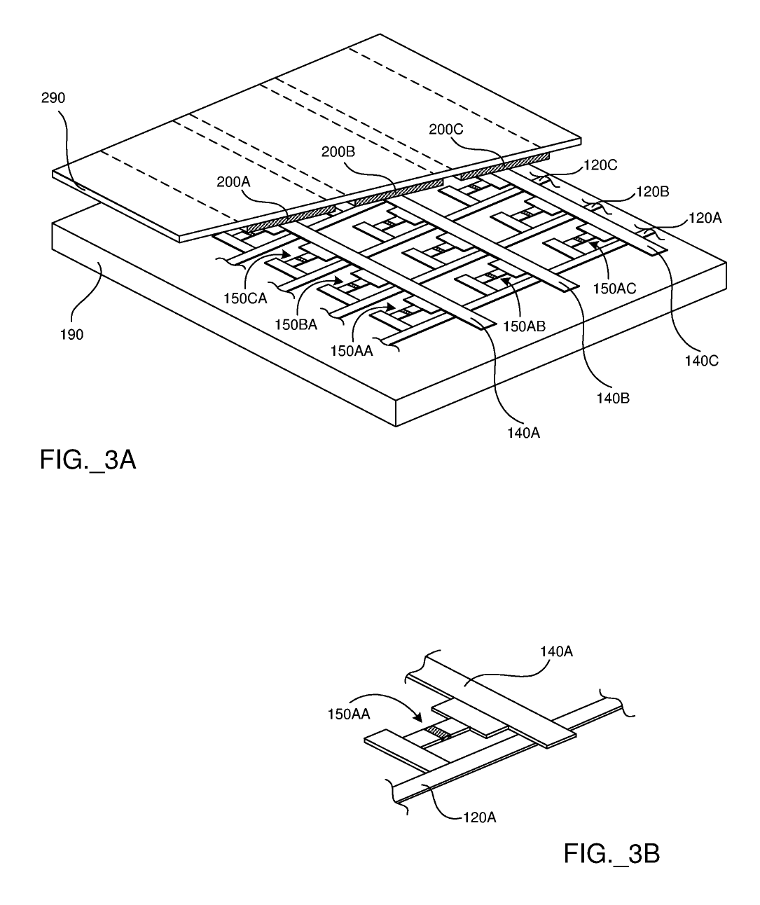

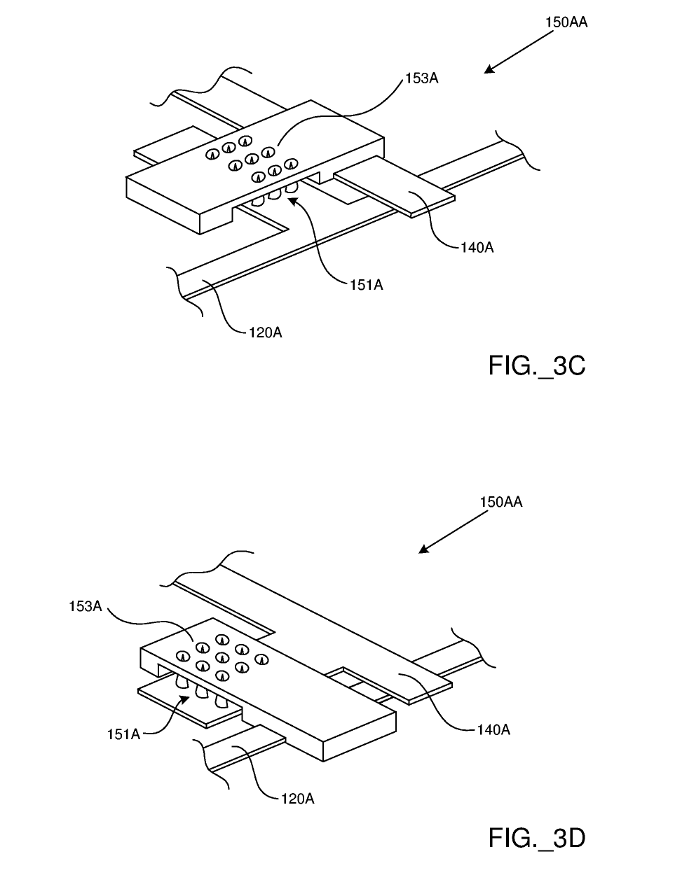

FIG. 3A shows that the array of anodes (e.g., 200A, 200B, and 200C) can be formed on a faceplate 290. FIG. 3A also shows that the array of selection lines (e.g., 120A, 120B, and 120C), the array of data driving lines (e.g., 140A, 140B, and 140C), and the matrix of electron-emitting elements can be formed on a substrate 190. FIG. 3B shows that an electron-emitting element 150AA can include a lateral cold cathode. Examples of lateral cold cathodes include surface conduction cathodes developed by Canon, or lateral nano-tube cathodes.

FIG. 3C and FIG. 3D illustrate that an electron-emitting element 150AA can include a vertical cold cathode. Examples of vertical cold cathodes include Spindt cathodes, or vertical nano-tube cathodes. FIG. 3C shows that selection line 120A can be connected to emitters 151A of the vertical cold cathode and data driving line 140A can be connected to a gate 153A of the vertical cold cathode. FIG. 3D shows that selection line 120A can be connected to a gate 153A of the vertical cold cathode and data driving line 140A can be connected to emitters 151A of the vertical cold cathode.

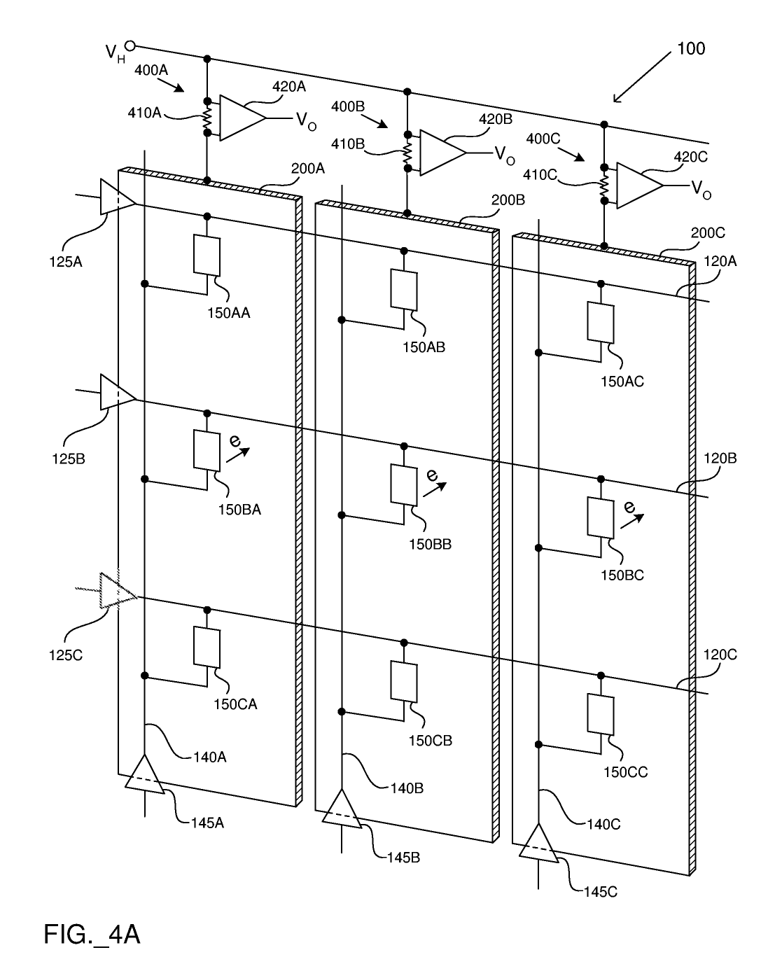

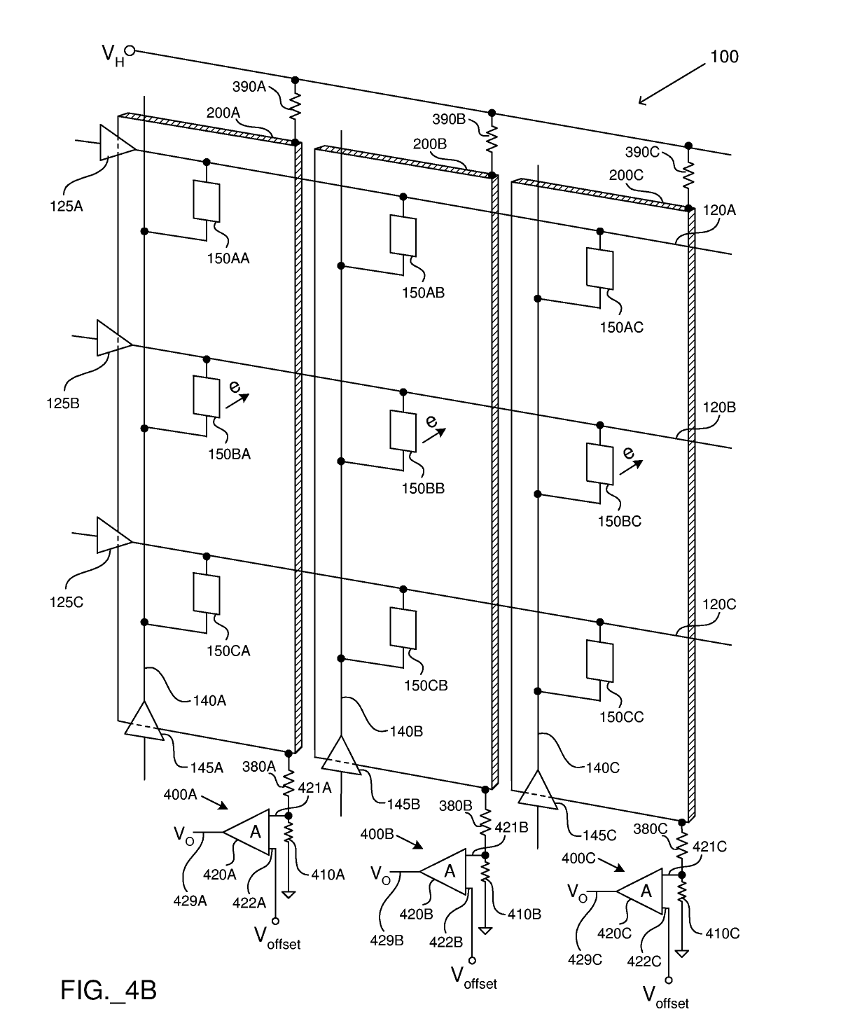

In the implementations as shown in FIG. 4A and FIG. 4B, a display device can also include a plurality of monitoring devices (e.g., 400A, 400B, and 400C). A monitoring device is electrically connected to an anode in the array of anodes. For example, monitoring device 400B is electrically connected to anode 200B. A monitoring device can be used to measure the current received by an anode from one or more electron-emitting elements. A monitoring device can also be used to measure the amount of electrons received by an anode from one or more electron-emitting elements.

FIG. 4A shows a specific implementation of the monitoring devices. In FIG. 4A, each monitoring device (e.g., 400A, 400B, or 400C) is used to measure the total current flowing out of an anode. Consequently, the current received by an anode from one or more electron-emitting elements can be measured. In FIG. 4A, a monitoring device (e.g., 400A, 400B, and 400C) is electrically connected between an anode and an anode voltage V_{H}.

In FIG. 4A, a monitoring device (e.g., 400A, 400B, or 400C) can include a sensing resistor (e.g., 410A, 410B, or 410C) and an instrumentation amplifier (e.g., 420A, 420B, or 410C). The sensing resistor (e.g., 410A, 410B, and 410C) is electrically connected between an anode (e.g., 200A, 200B, or 200C) and an anode voltage V_{H}. The instrumentation amplifier (e.g., 420A, 420B, and 420C) can be used to measure a voltage V_{S} across the sensing resistor (e.g., 410A, 410B, and 410C). If the resistive value of the sensing resistor is R_{S}, the voltage V_{S} across the sensing resistor (e.g. 410B) is related to the current Iₑ received by the anode (e.g., 200B) and follows the equation, V_{S}=R_{S}·Iₑ. Therefore, the current Iₑ received by the anode (e.g., 200B) can be determined from the voltage V_{S} across the sensing resistor (e.g., 410B), Iₑ=V_{S}/R_{S}.

In FIG. 4A, each monitoring device (e.g., 400A, 400B, or 400C) can also be used to measure an amount of charges received by an anode (e.g., 200A, 200B, or 200C) from one or more electron-emitting elements during a predetermined time period. If the voltage output from the instrumentation amplifier (e.g., 400B) is connected to a time-integration circuit, the time integration of the voltage V_{S} across the sensing resistor (e.g., 410B) can be measured. Because the time integration of the current Iₑ received by the anode (e.g., 200B) is the total charge Qₑ received by the anode (e.g., 200B) during the integration time period, Qₑ=∫Iₑ(t)dt, the total charge Qₑ received by the anode (e.g., 200B) can be measured. The total charge Qₑ received by the anode (e.g., 200B) can be determined from the time integration of the voltage V_{S} across the sensing resistor (e.g., 410B), Qₑ=(∫V_{S}(t)dt)/R_{S}.

FIG. 4B shows another specific implementation of the monitoring devices. In FIG. 4B, each monitoring device (e.g., 400A, 400B, or 400C) is used to measure a predetermined fraction of the current flowing out of an anode. Consequently, the current received by an anode from one or more electron-emitting elements can be measured. In FIG. 4B, an anode (e.g., 200A, 200B, or 200C) is electrically connected to an anode voltage V_{H} though a load resistor (e.g., 390A, 390B, or 390C). The resistive value of the load resistor is R_{H}. An anode (e.g., 200A, 200B, or 200C) is electrically connected to a monitoring device (e.g., 400A, 400B, and 400C) through a coupling resistor (e.g., 380A, 380B, or 380C). The resistive value of the coupling resistor is R_{C}.

In FIG. 4B, a monitoring device (e.g., 400A, 400B, or 400C) can include a sensing resistor (e.g., 410A, 410B, or 410C) and an amplifier (e.g., 420A, 420B, or 420C). The resistive value of the sensing resistor is R_{S}. An amplifier (e.g., 420B) includes a first input (e.g., 421B), a second input (e.g., 422B), and an output (e.g., 429B). The amplifier (e.g., 420B) can generate a voltage Vₒ at the output (e.g., 429B). In one implementation, the voltage Vₒ is proportional to a voltage difference between an input voltage V₁ received at the first input (e.g., 421B) and an input voltage V₂ received at the second input (e.g. 422B), that is, Vₒ=A(V₁−V₂), where coefficient A is the gain of the amplifier (e.g., 420B).

The amplifier (e.g., 420B) can be used to measure a voltage at a terminal of the sensing resistor (e.g., 410B). It can be shown that the voltage V₁ at the first input (e.g., 421B) of the amplifier (e.g., 420B) is related to the current Iₑ received by the anode (e.g., 200B). More specifically, V₁=−[R_{H} R_{S}/(R_{H}+R_{C}+R_{S})]·Iₑ+[R_{S}/(R_{H}+R_{C}+R_{S})]·V_{H}. When the second input (e.g. 422B) of the amplifier (e.g., 420B) is connected to an offset voltage, V₂=V_{offset}=[R_{S}/(R_{H}+R_{C}+R_{S})]·V_{H}, the voltage Vₒ at the output (e.g., 429B) of the amplifier (e.g., 420B) is given by Vₒ=−A[R_{H}R_{S}/(R_{H}+R_{C}+R_{S})]·Iₑ. Therefore, the electric current received by the anode (200B) from one or more electron-emitting elements can be measured by measuring the voltage Vₒ at the output (e.g., 429B) of the amplifier (e.g., 420B), Iₑ=−Vₒ(R_{H}+R_{C}+R_{S})/R_{H}R_{S}A.

In FIG. 4B, each monitoring device (e.g., 400A, 400B, or 400C) can also be used to measure an amount of charges received by an anode (e.g., 200A, 200B, or 200C) from one or more electron-emitting elements during a predetermined time period. For example, when the output (e.g. 429B) of the amplifier (e.g., 420B) is connected to a time-integration circuit, the output voltage V_{Q} of the time-integration circuit will be related to the total charge Qₑ received by an anode (e.g., 200B). More Specifically, V_{Q}=·BA[R_{H}R_{S}/(R_{H}+R_{C}+R_{S})]·Qₑ, where coefficient B is a proportional constant of the time-integration circuit, and the total charge Qₑ received by the anode (e.g., 200B) is a time integration of the current Iₑ received by the anode (e.g., 200B), that is, Qₑ=∫Iₑ(t)dt. Therefore, the total charge Qₑ received by the anode (e.g., 200B) can be determined from the output voltage V_{Q}, Qₑ=−V_{Q}(R_{H}+R_{C}+R_{S})/R_{II}R_{S}AB.

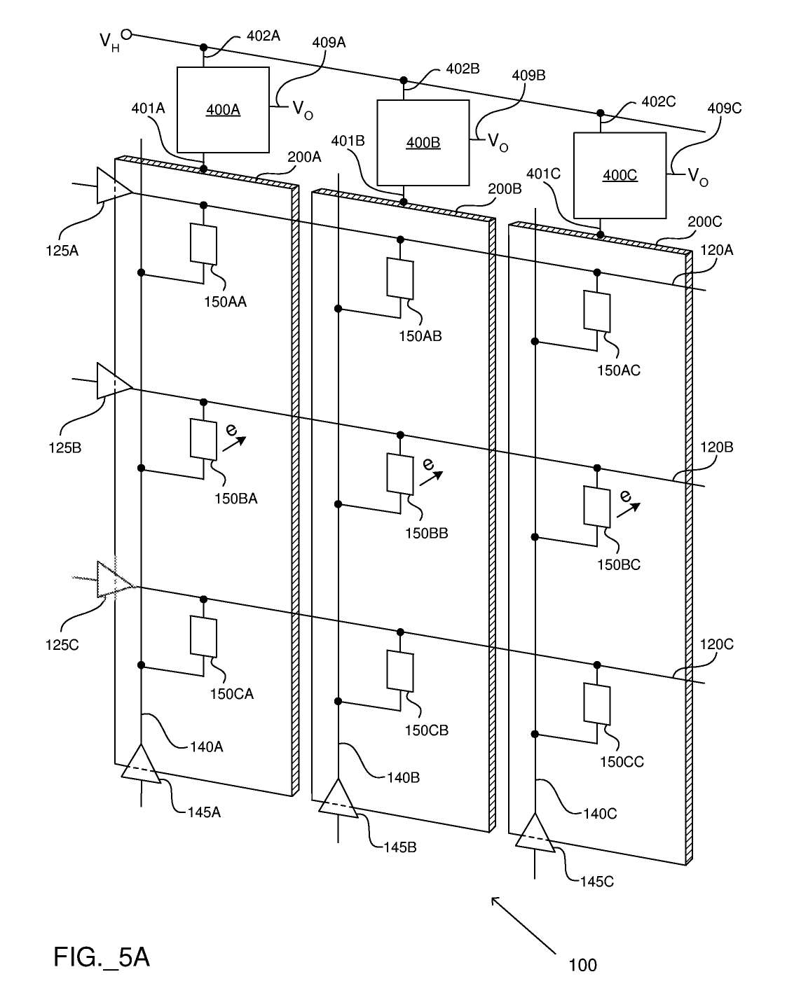

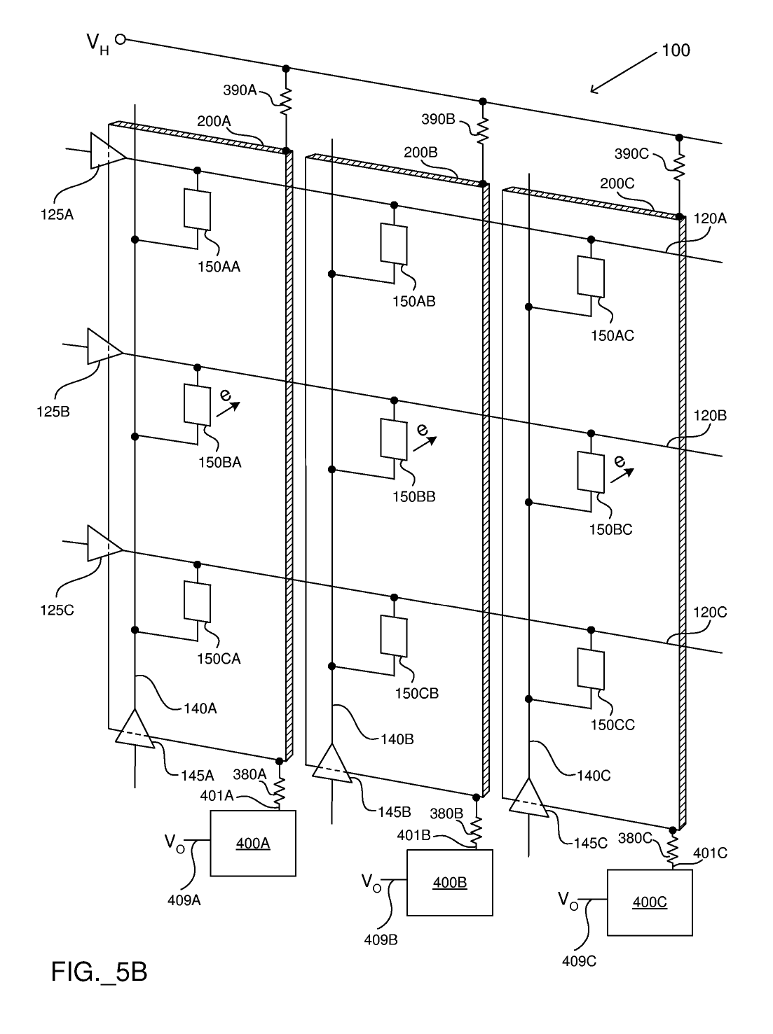

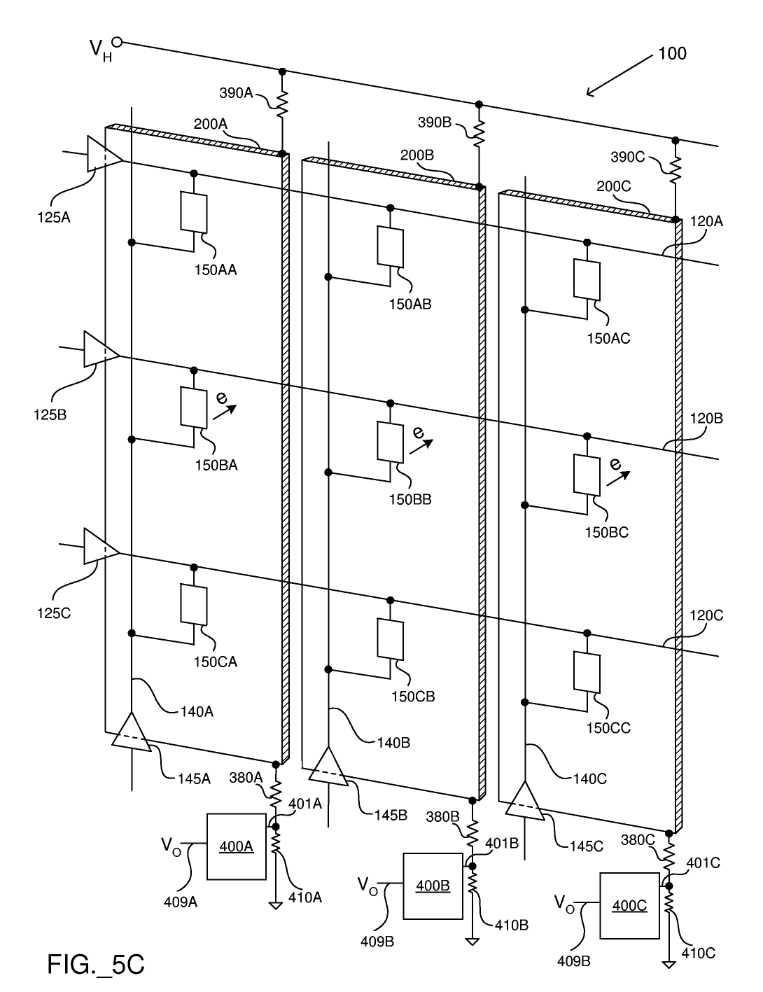

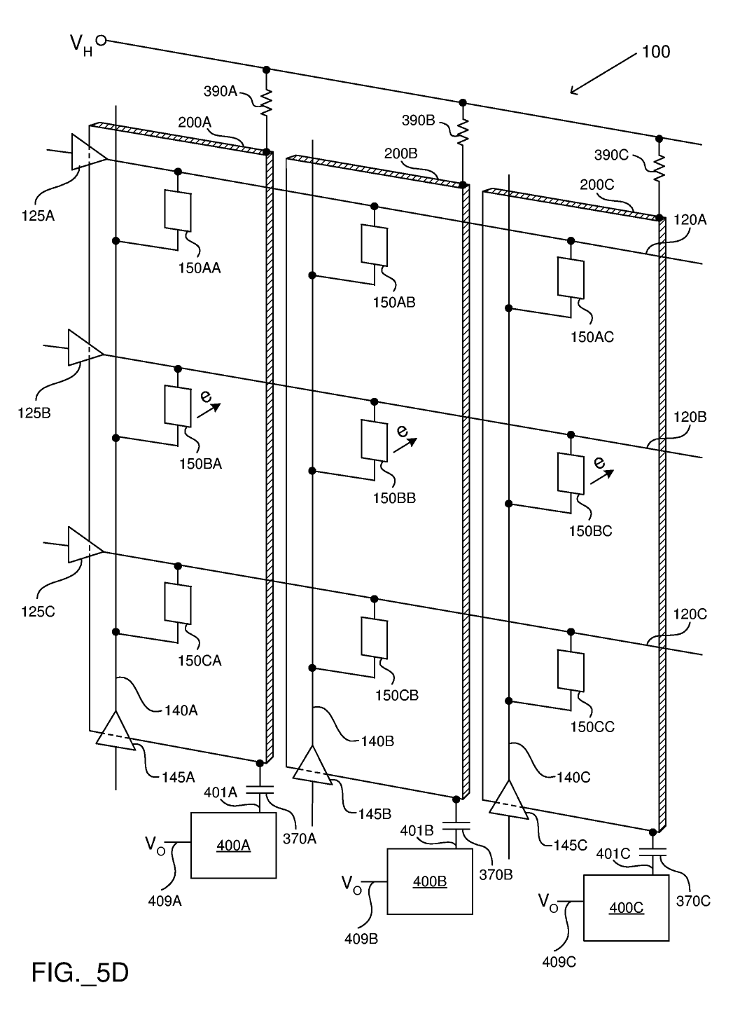

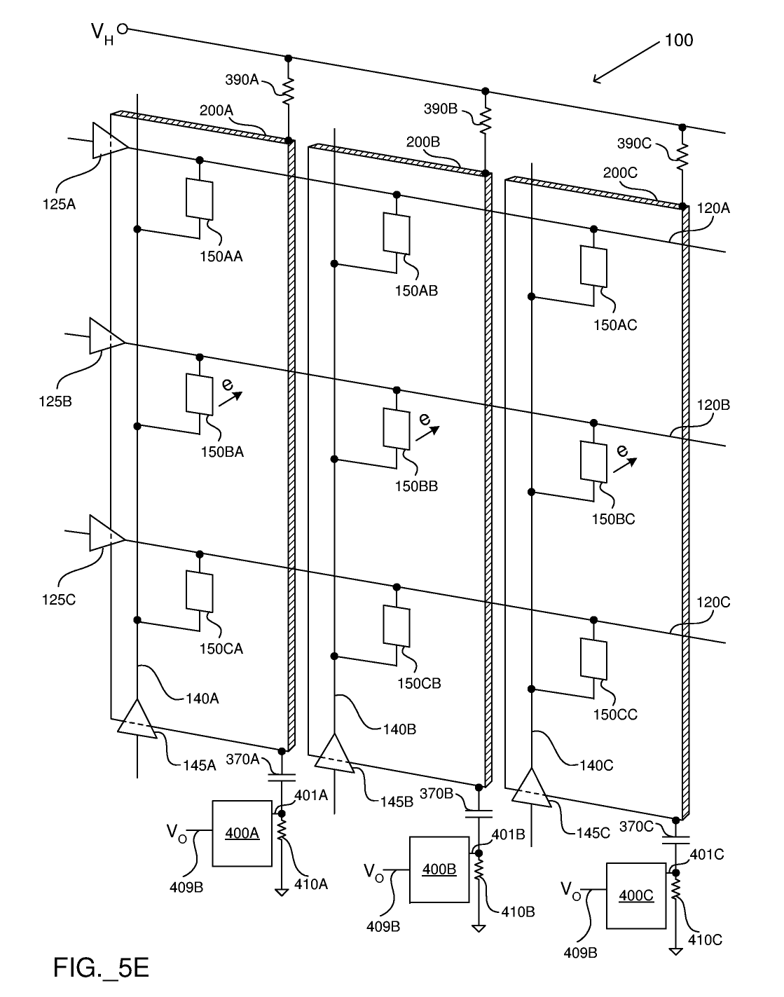

FIG. 5A-FIG. 5E each shows a display device that includes a plurality of monitoring devices (e.g., 400A, 400B, and 400C). FIG. 5A-FIG. 5E also illustrate some general implementations of the monitoring devices. Many specific implementations of the monitoring devices are possible. Based on the teachings in the present disclosure, people skilled in the art can select the specific implementations that best serve their design needs or product specifications.

In FIG. 5A, a monitoring device (e.g., 400B) includes a first input (e.g., 401B), a second input (e.g., 402B), and an output (e.g., 409B). A signal at the output (e.g., 409B), such as a voltage signal of a current signal, is related to the current Iₑ receive by the anode (e.g., 200B) from one or more electron-emitting elements. When the monitoring device (e.g., 400B) in FIG. 5A is specifically implemented with the electronic circuit as shown in FIG. 4A, the voltage Vₒ at the output (e.g., 409B) of the monitoring device (e.g., 400B) is directly proportional to the current Iₑ received by the anode (e.g., 200B). More specifically, Vₒ=A·R_{S}·Iₑ, where coefficient A is the gain of the amplifier (e.g., 420B) and R_{S} is the resistive value of the sensing resistor (e.g., 410B). Alternatively, when the monitoring device (e.g., 400B) in FIG. 5A is specifically implemented with other kinds of circuits, the voltage at the output (e.g., 409B) of the monitoring device (e.g., 400B) can depend on the current Iₑ with other kinds of functional relationship, such as, Vₒ=f(Iₑ), where f(x) describes a predetermined function. In some specific implementations of the monitoring device (e.g., 400B), the signal at the output (e.g., 409B) of the monitoring device (e.g., 400B) can be proportional to the total charge Qₑ received by the anode (e.g., 200B), that is, Vₒ=β·Qₑ, where β is a proportional constant.

In FIG. 5B, a monitoring device (e.g., 400B) is electrically connected to an anode (e.g., 200B) through a coupling resistor (e.g., 380B). The monitoring device (e.g., 400B) includes an input (e.g., 401B), and an output (e.g., 409B). A signal at the output (e.g., 409B), such as a voltage signal of a current signal, is related to the current Iₑ received by the anode (e.g., 200B) from one or more electron-emitting elements. When the monitoring device (e.g., 400B) in FIG. 5B is specifically implemented with the electronic circuit as shown in FIG. 4B, the voltage Vₒ at the output (e.g., 409B) of the monitoring device (e.g., 400B) can be linearly related to the current Iₑ received by the anode (e.g., 200B), that is, Vₒ=α·Iₑ+δ, where α is a proportional constant and δ is an offset constant. In the specific implementation as shown in FIG. 4B, when the offset voltage at the second input (e.g., 422B) of the amplifier (e.g., 420B) is specially selected, the voltage Vₒ can be directly proportional to the current Iₑ that is, δ=0 and α=−A[R_{H}R_{S}/(R_{H}+R_{C}+R_{S})]. Alternatively, when the monitoring device (e.g., 400B) in FIG. 5B is specifically implemented with other kinds of circuits, the voltage Vₒ at the output (e.g., 409B) of the monitoring device (e.g., 400B) can depend on the current Iₑ with other kinds of functional relationships, such as, Vₒ=f(Iₑ), where f(x) describes a predetermined function. In some specific implementations of the monitoring device (e.g., 400B), the signal at the output (e.g., 409B) of the monitoring device (e.g., 400B) can be proportional to the total charge Qₑ received by the anode (e.g., 200B), that is, Vₒ=β·Qₑ, where β is a proportional constant.

In FIG. 5C, a monitoring device (e.g., 400B) is electrically connected to an anode (e.g., 200B) through a coupling resistor (e.g., 380B). The coupling resistor (e.g., 380B) is electrically connected to a common voltage through a sensing resistor (e.g., 410B). The monitoring device (e.g., 400B) has an input (e.g., 401B) that is connected to the sensing resistor (e.g., 410B) to measure a voltage at a terminal of the sensing resistor (e.g., 410B). Because a voltage across the sensing resistor (e.g., 410B) is related to the current Iₑ received by the anode (e.g., 200B) from one or more electron-emitting elements, a signal at the output (e.g., 409B) of the monitoring device, such as a voltage signal or a current signal, is also related to the current Iₑ. Generally, the voltage Vₒ at the output (e.g., 409B) of the monitoring device (e.g., 400B) can depend on the current Iₑ with a predetermined functional relationship, such as, Vₒ=f(Iₑ), where f(x) describes a predetermined function, In some specific implementations of the monitoring device (e.g., 400B), the voltage Vₒ at the output (e.g., 409B) of the monitoring device (e.g., 400B) can be linearly related to the current Iₑ received by the anode (e.g., 200B), that is, Vₒ=α·Iₑ+δ, where α is a proportional constant and δ is an offset constant. In some specific implementations of the monitoring device (e.g., 400B), the signal at the output (e.g., 409B) of the monitoring device (e.g., 400B) can be proportional to the total charge Qₑ received by the anode (e.g., 200B), that is, Vₒ=β·Qₑ, where β is a proportional constant.

In FIG. 5D, a monitoring device (e.g., 400B) is electrically connected to an anode (e.g., 200B) through a coupling capacitor (e.g., 370B). A signal at the output (e.g., 409B), such as a voltage signal or a current signal, can be related to the current Iₑ received by the anode (e.g., 200B) from one or more electron-emitting elements.

In FIG. 5E, a monitoring device (e.g., 400B) is electrically connected to an anode (e.g., 200B) through a coupling capacitor (e.g., 370B). The coupling capacitor (e.g., 370B) is electrically connected to a common voltage through a sensing resistor (e.g., 410B). The monitoring device (e.g., 400B) has an input (e.g., 401B) that is connected to the sensing resistor (e.g., 410B) to measure a voltage at a terminal of the sensing resistor (e.g., 410B). Because a voltage across the sensing resistor (e.g., 410B) is related to the current Iₑ received by the anode (e.g., 200B) from one or more electron-emitting elements, a signal at the output (e.g., 409B), such as a voltage signal or a current signal, is also related to the current Iₑ.

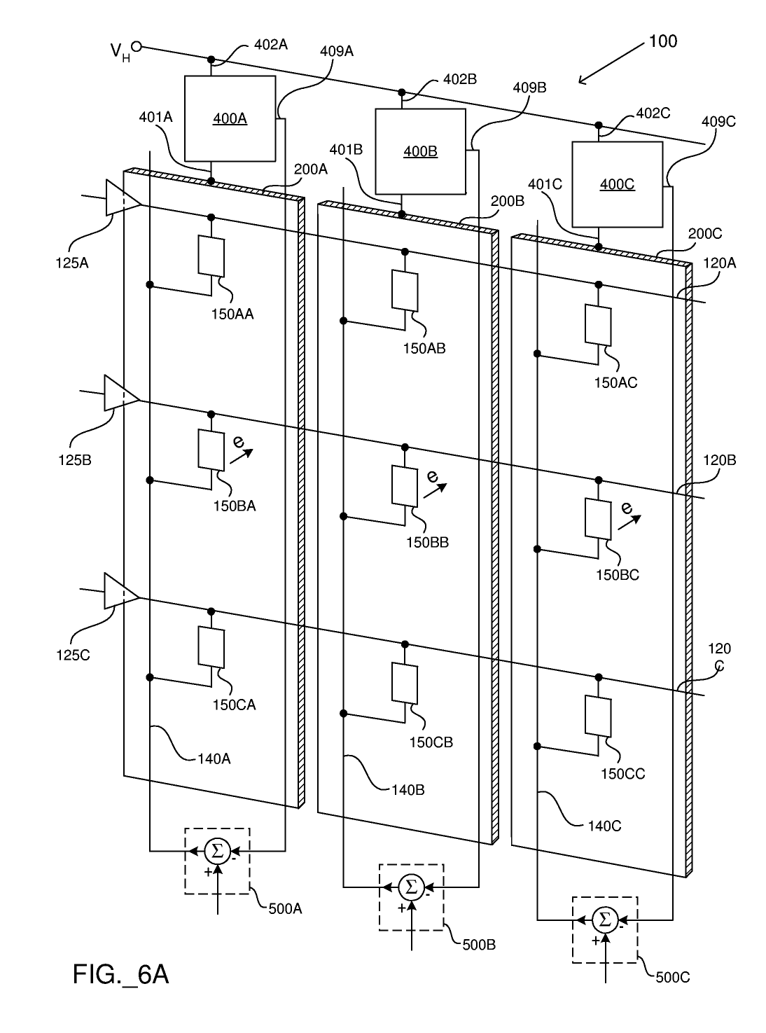

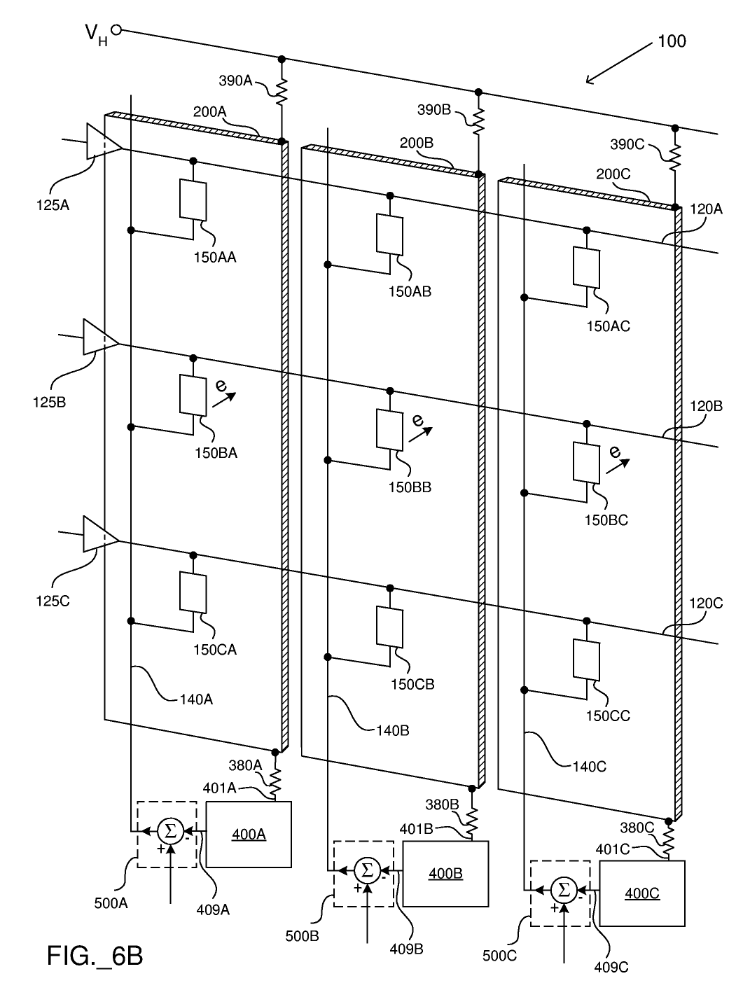

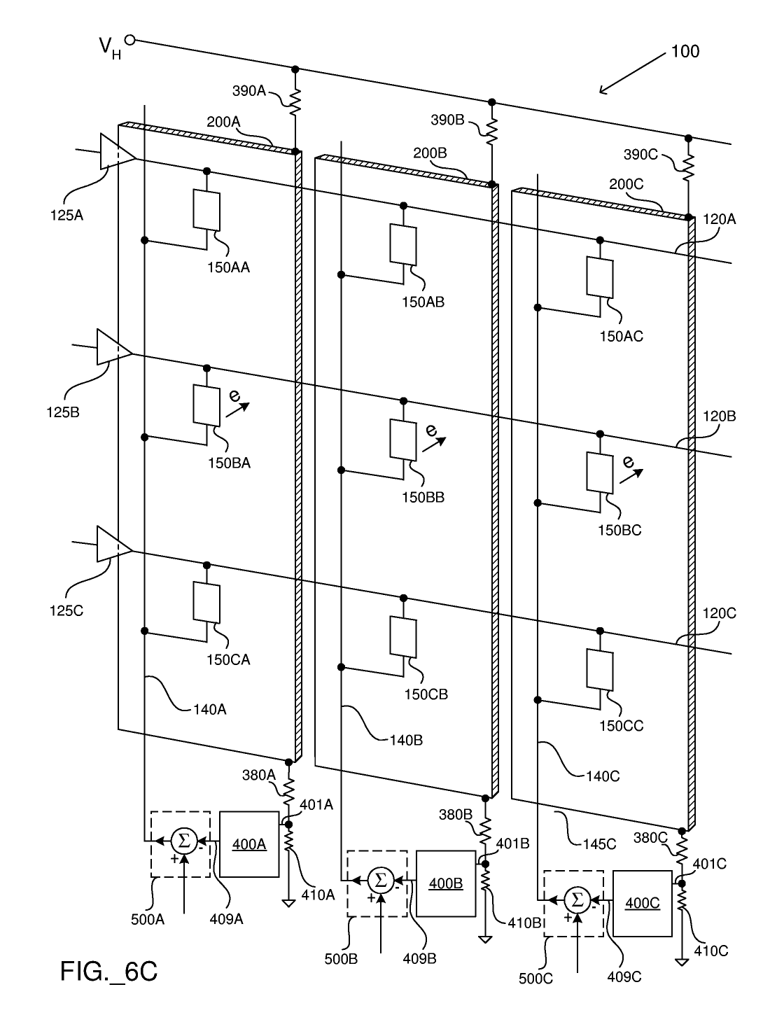

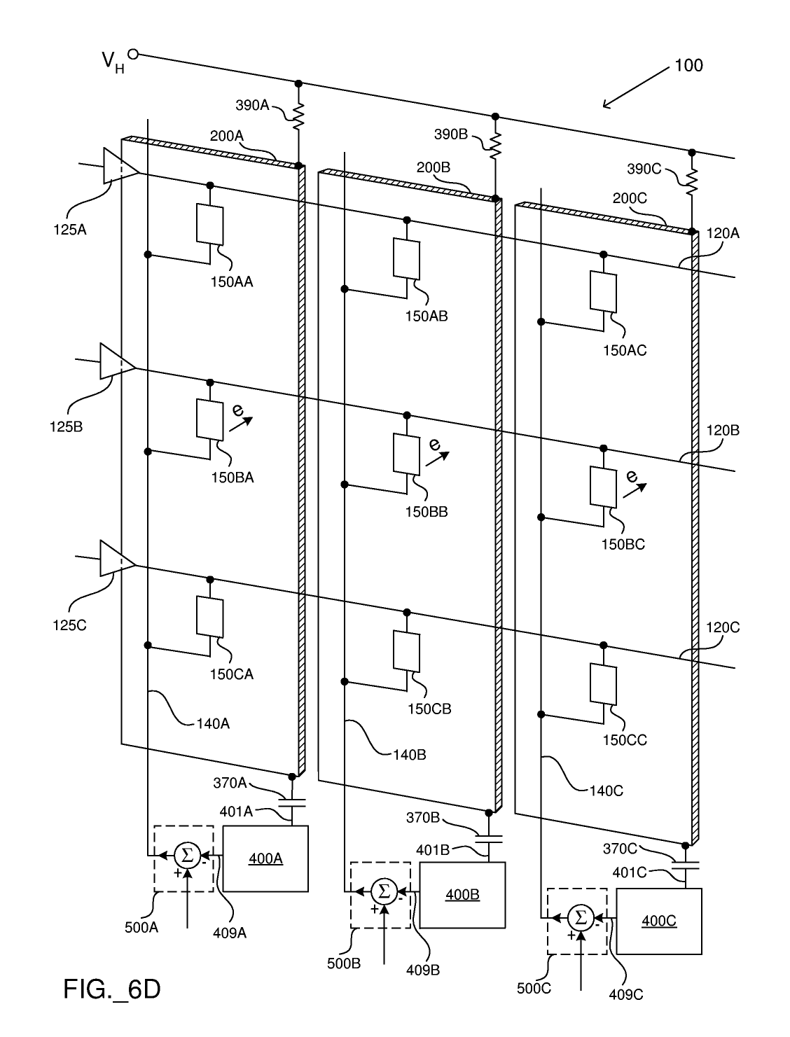

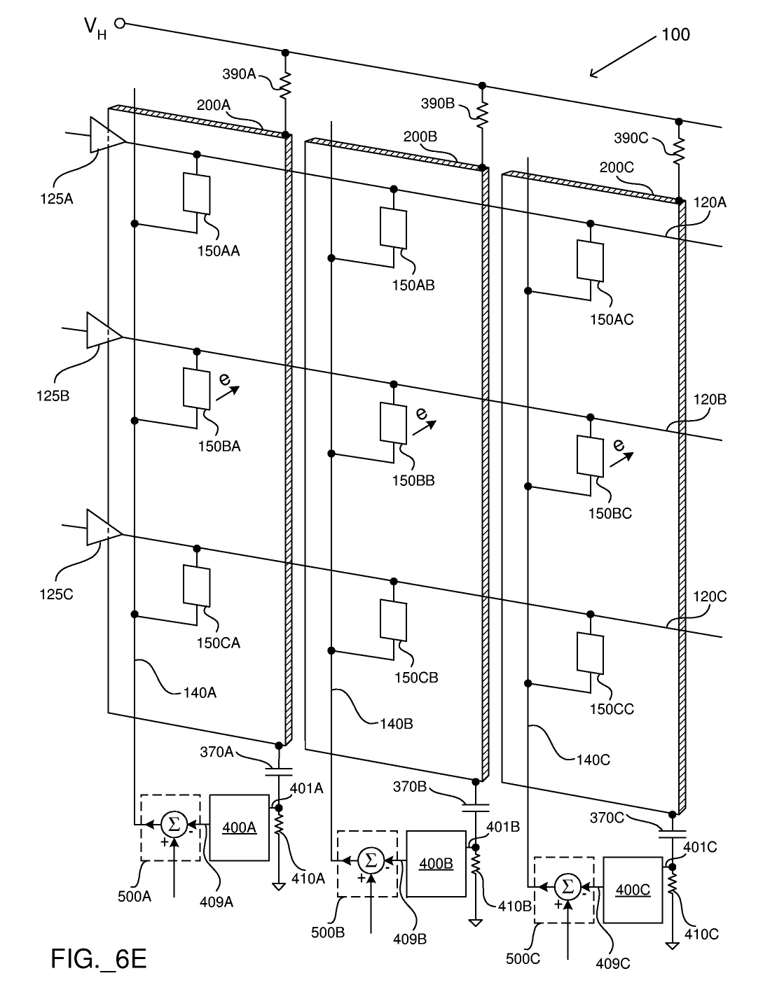

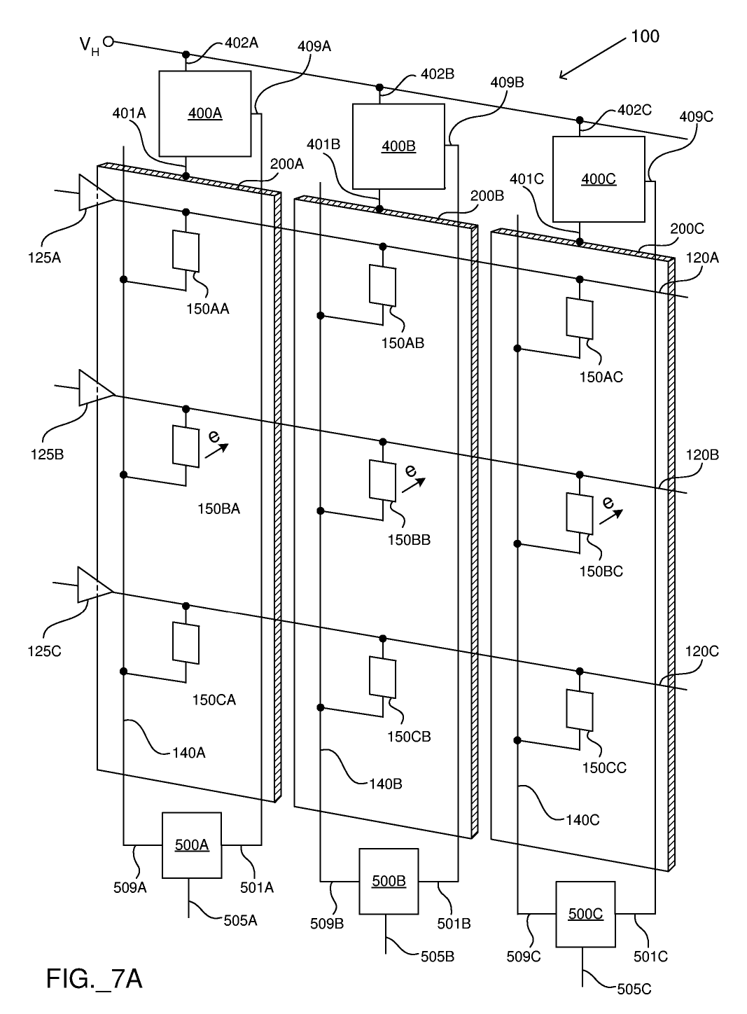

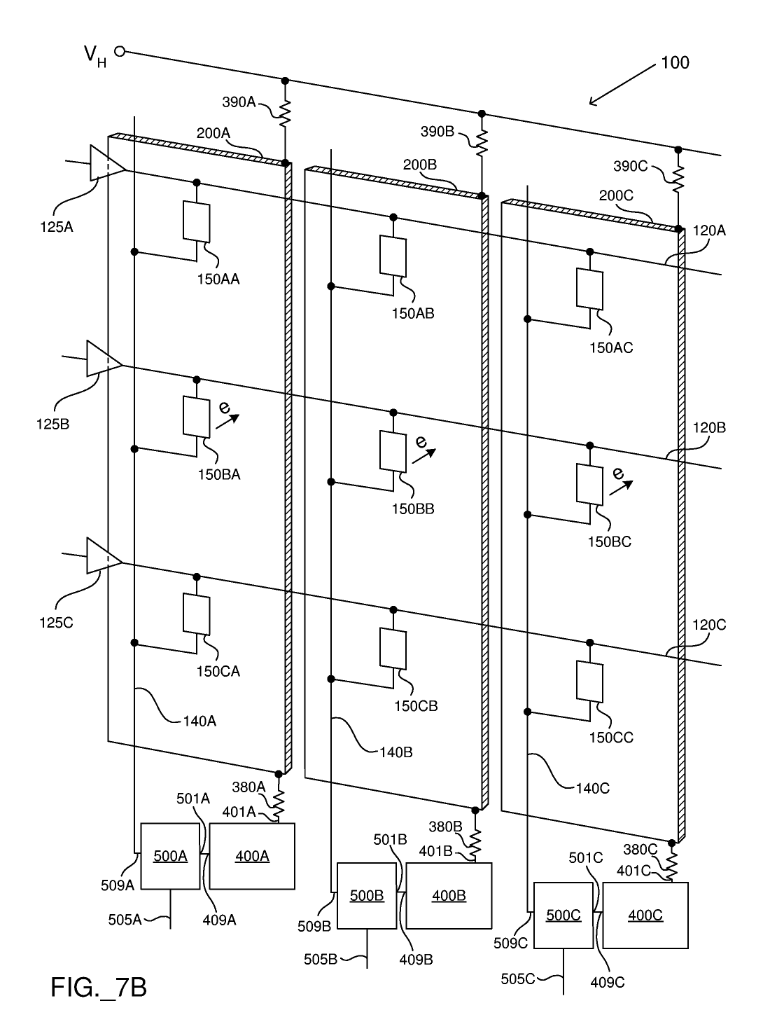

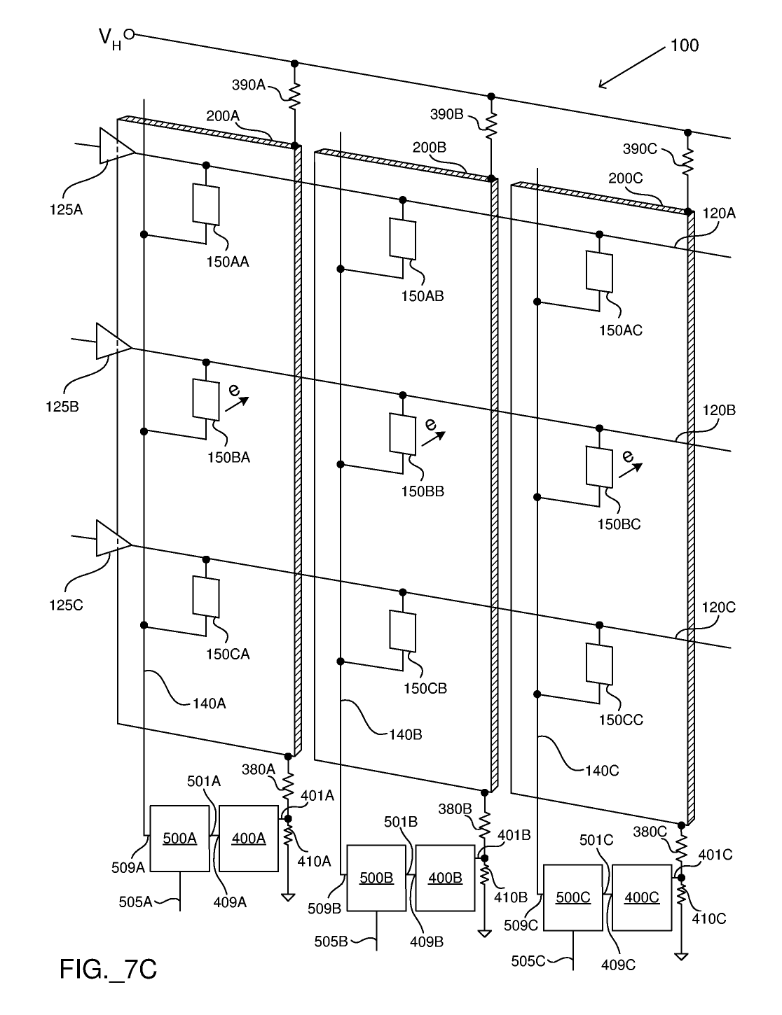

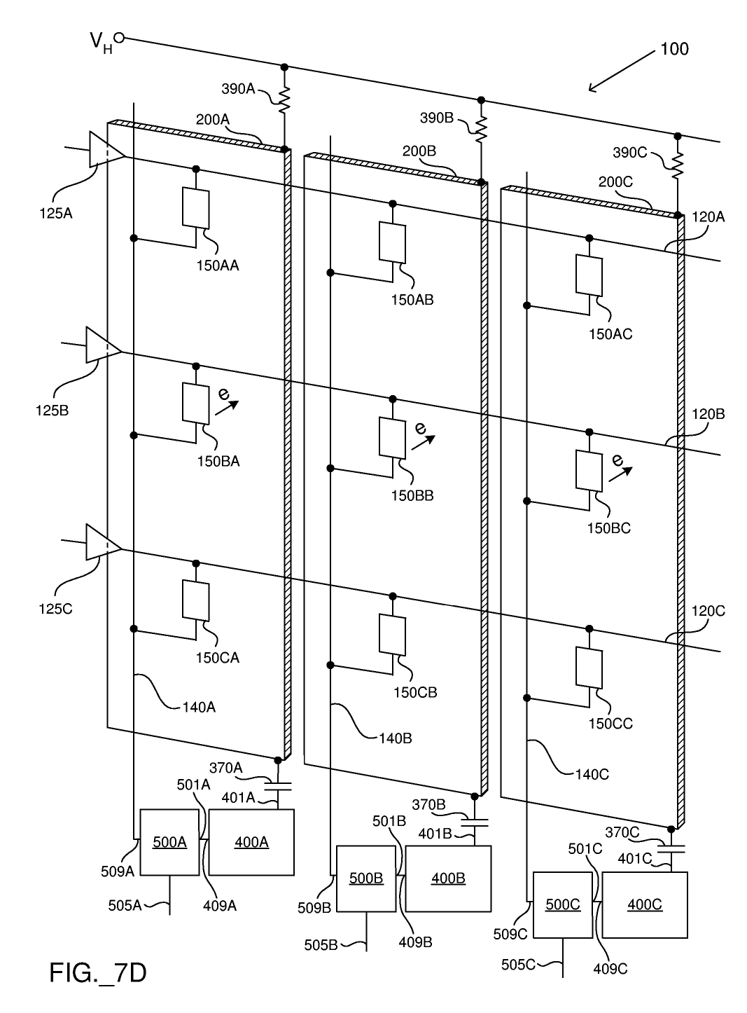

FIG. 6A-FIG. 6E illustrate some other implementations of a display device. The display device in FIG. 6A-FIG. 6E includes an array of data drivers (e.g., 500A, 500B, and 500C). In the display device, a data driving line can be electrically connected to a data driver that receives a feedback signal from an anode in the array of anodes. For example, data driving line 140B can be electrically connected to data driver 500B that receives a feedback signal from anode 200B. In the implementations as shown in FIG. 6A-FIG. 6E, the display device includes a plurality of monitoring devices (e.g., 400A, 400B, and 400C), a data driver can receive a feedback signal from an anode in such a way that the data driver receives the feedback signal from a monitoring device. For example, data driver 500B can receive a feedback signal from monitoring device 400B.

The data drivers can be configured to drive electron-emitting elements in negative feedback loops. The negative feedback loops can be an analog control loop, a digital control loop, or a combination of an analog and a digital control loop. The negative feedback loop can be a proportional control loop, a proportional integration control loop, a proportional differential control loop, a proportional differential integration control loop, or a nonlinear control loop. In some implementations, the negative feedback loop can be a bang-bang control loop.

In the implementations as shown in FIG. 6A-FIG. 6E, a data driver can be configured to receive a feedback signal from a monitoring device. In some implementations, a monitoring device can be a part of a data driver, and a data driver having a monitoring device therein can be configured to receive a feedback signal from an anode.

FIG. 7A-FIG. 7E each illustrates a display device that includes an array of data drivers (e.g., 500A, 500B, and 500C) and a plurality of monitoring devices (e.g., 400A, 400B, and 400C). A monitoring device (e.g., 400B) includes an output (e.g., 409B) operative to generate an output signal (such as a voltage output signal or current output signal) that is related to the current received by the anode (e.g., 200B) or the total charge received by the anode (e.g., 200B). A data driver (e.g., 500B) can include a sensing input (e.g., 501B), a reference input (e.g., 505 B), and a data output (e.g., 509B). The sensing input (e.g., 501B) of the data driver (e.g., 500B) can receive a sensing signal from the output (e.g., 409B) of the monitoring device (e.g., 400B). The reference input (e.g., 505 B) of the data driver (e.g., 500B) can receive a reference signal that can be used to set a target value of the current received by the anode (e.g., 200B) or a target value of the total charge received by the anode (e.g., 200B). The data output (e.g., 509B) of the data driver (e.g., 500B) can generate a data signal that is related to both the received reference signal and the received sensing signal. In some implementations, the data drivers are close loop control drivers. In other implementations, the data drivers are open loop control drivers.

In the implementations as shown in FIG. 7A-FIG. 7E, a data driver can be configured to receive a sensing signal from a monitoring device. In some implementations, a monitoring device can be a part of a data driver, and a data driver having a monitoring device therein can be configured to receive a sensing signal from an anode.

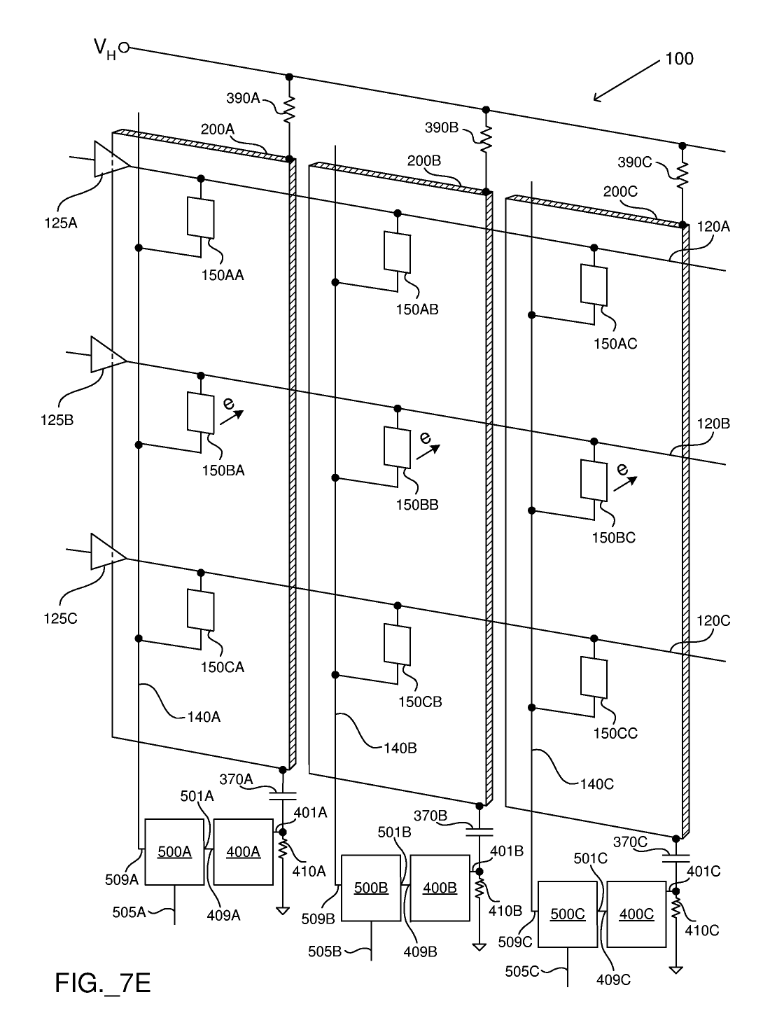

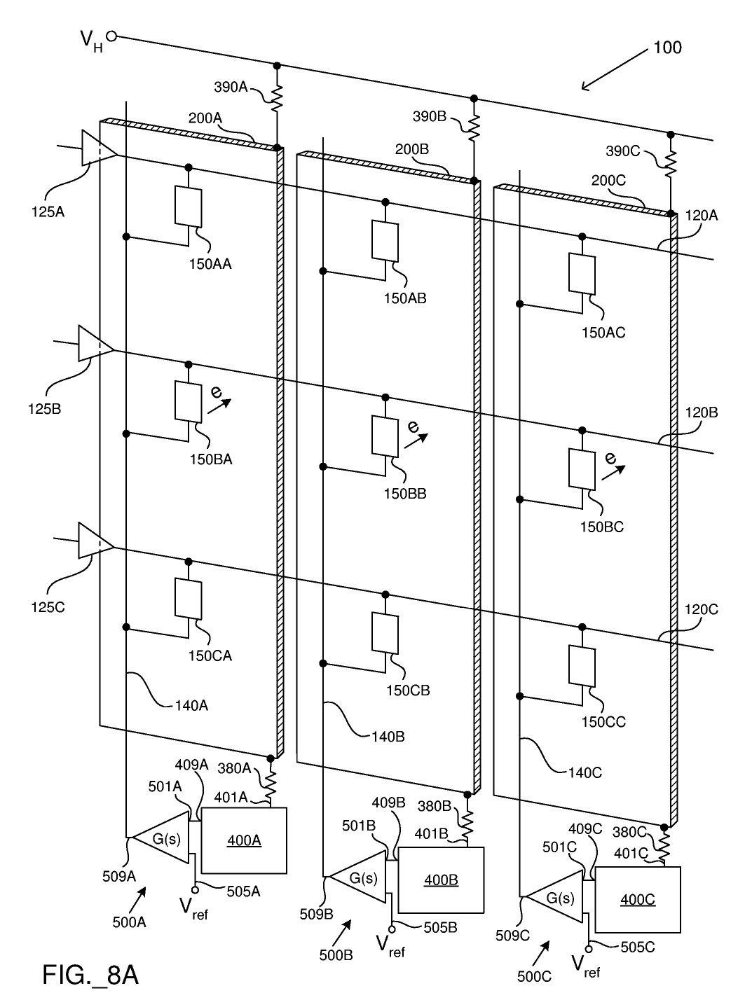

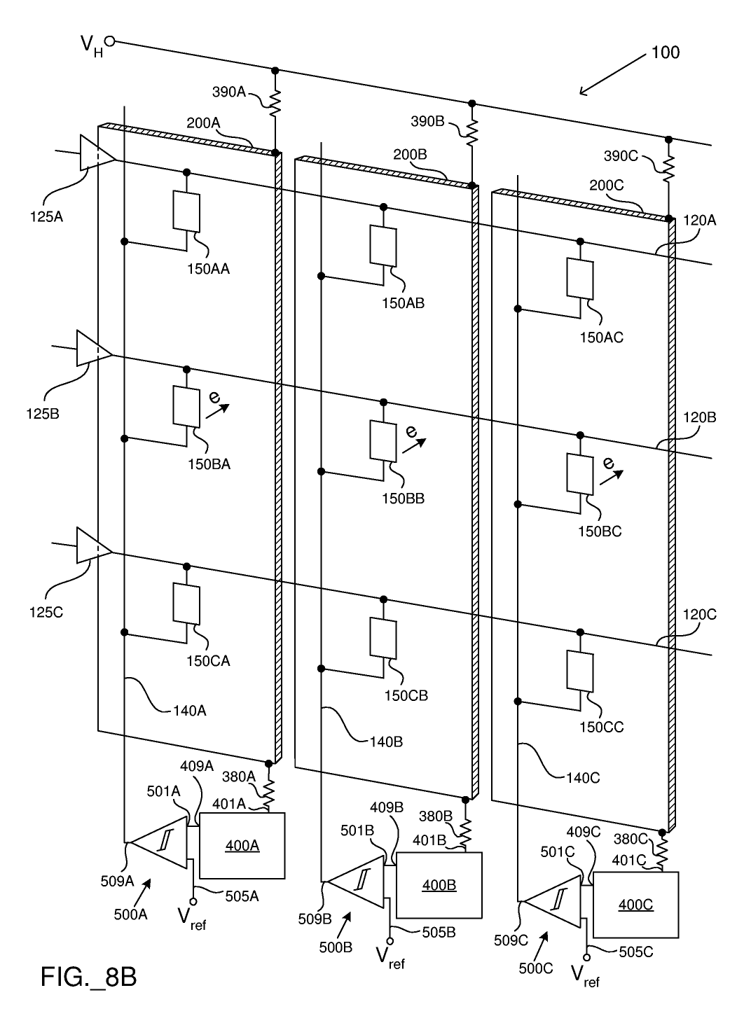

FIG. 8A shows an exemplary implementation of the data driver (e.g., 500B). In FIG. 8A, the data output (e.g., 509B) of the data driver (e.g., 500B) can generate a data voltage V_{data} that is linearly depend upon the difference between the received reference signal V_{ref} and the received sensing signal Vₒ. In Laplace space, V_{data}(s)=G(s)[V_{ref}−Vₒ(s)]+C, where V_{data}(s) and Vₒ(s) are respectively the Laplace representations of the time-domain data voltage V_{data}(t) and the time-domain received sensing signal Vₒ(t), C is a constant, and G(s) is the response function of the data driver (e.g., 500B) in Laplace space. When the monitoring device (e.g., 400B) is designed in such a way that the voltage Vₒ at the output (e.g., 409B) is directly proportional to the current Iₑ received by the anode (e.g., 200B) and follows equation Vₒ=α·Iₑ, the data voltage V_{data} will follows the equation, V_{data}(s)=α(G(s)[(V_{ref}/α)−Iₑ(s)]+C.

When the data driver (e.g., 500B) is properly designed, the current Iₑ received by the anode (e.g., 200B) can be settled at a target value. As examples, when the electronic current received by anode 200B from electron-emitting element 150BB is larger than a target value, data driver 500B will drive electron-emitting element 150BB in such a way to decrease the electronic current received by anode 200B from electron-emitting element 150BB. On the other hand, when the electronic current received by anode 200B from electron-emitting element 150BB is smaller than a target value, data driver 500B will drive electron-emitting element 150BB in such a way to increase the electronic current received by anode 200B from electron-emitting element 150BB. Consequently, with a properly designed control circuit, the electronic current received by anode 200B from electron-emitting element 150BB can be settled at a predetermined target value within certain time constant (which may depend on the quality of the design of the control circuit). Further, if there are any changes in the emission properties of electron-emitting element 150BB, data driver 500B can make adjustment and compensate any changes of the electronic current received by anode 200B from electron-emitting element 150BB. Therefore, the electronic current received by anode 200B from electron-emitting element 150BB can be set substantially close to a predetermined target value, even if the emission properties of electron-emitting element 150BB changes or differs from some nominal emission properties of an ideal electron-emitting element.

In some implementations, the electronic current received by a given anode from a given electron-emitting element can be set substantially close to a predetermined target value. In other implementations, the amount of charge received by a given anode from a given electron-emitting element can be set substantially close to a predetermined target value. For example, when the monitoring device (e.g., 400B) is designed in such a way that the voltage Vₒ at the Output (e.g., 409B) is directly proportional to the amount of charge Qₑ received by the anode (e.g., 200B) and follows equation Vₒ=β·Qₑ, the data voltage V_{data} will follows the equation, V_{data}(s)=βG(s)[(V_{ref}/β)−Qₑ(s)]+C. Therefore, the amount of charge Qₑ received by anode 200B from electron-emitting element 150BB can be set substantially close to a predetermined target value, even if the emission properties of electron-emitting element 150BB changes or differs from some nominal emission properties of an ideal electron-emitting element.

FIG. 8B shows another exemplary implementation of the data driver (e.g., 500B). In FIG.8B, the data driver (e.g., 500B) receives a sensing signal from the output (e.g., 409B) of the monitoring device (e.g., 400B). The monitoring device (e.g., 400B) is design in such a way that the voltage Vₒ at the output (e.g., 409B) is directly proportional to the amount of charge Qₑ received by the anode (e.g., 200B), that is, Vₒ=β·Qₑ. The data driver (e.g., 500B) includes a comparator. The data driver (e.g., 500B) generates an output data signal (such as a voltage data signal or a current data signal) when Vₒ<V_{ref}, the data driver (e.g., 500B) generates no output signal when Vₒ>V_{ref}.

In operation, when the amount of charge received by the anode (e.g., 200B) is less than a target value Q_{target}=V_{ref}/β, the data driver (e.g., 500B) will enable an electro-emitting element (e.g., 150BB) to emit electrons to the anode (e.g., 200B). When the amount of charge received by the anode (e.g., 200B) reaches a target value Q_{target}=V_{ref}/β, the data driver (e.g., 500B) will stop to generate output signals and the electron-emitting element (e.g., 150BB) will stop to emit electrons. Therefore, the amount of charge received by the anode (e.g., 200B) from the electron-emitting element (e.g., 150BB) can be set to a target value Q_{target}=V_{ref}/β by setting the correct value of the reference signal V_{ref} received by the data driver (e.g., 500B).

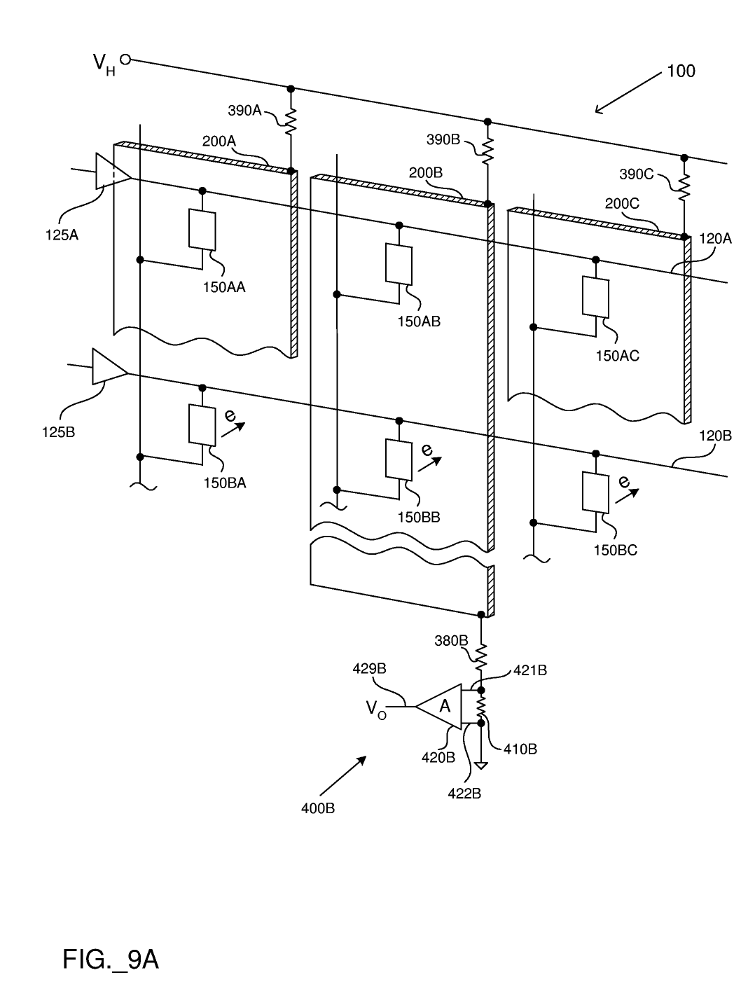

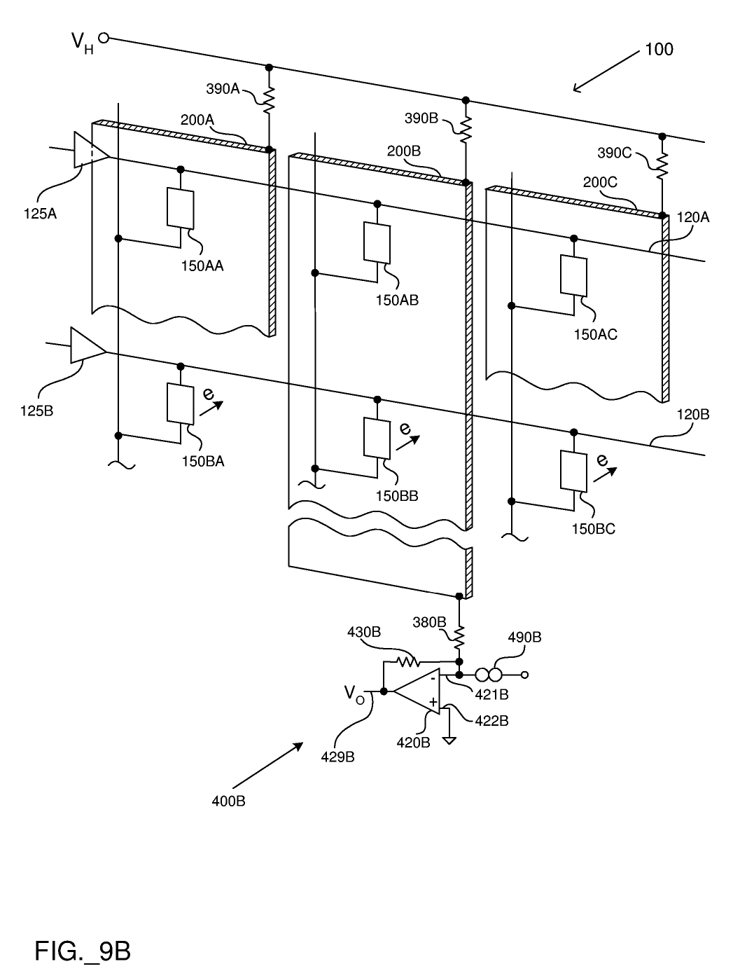

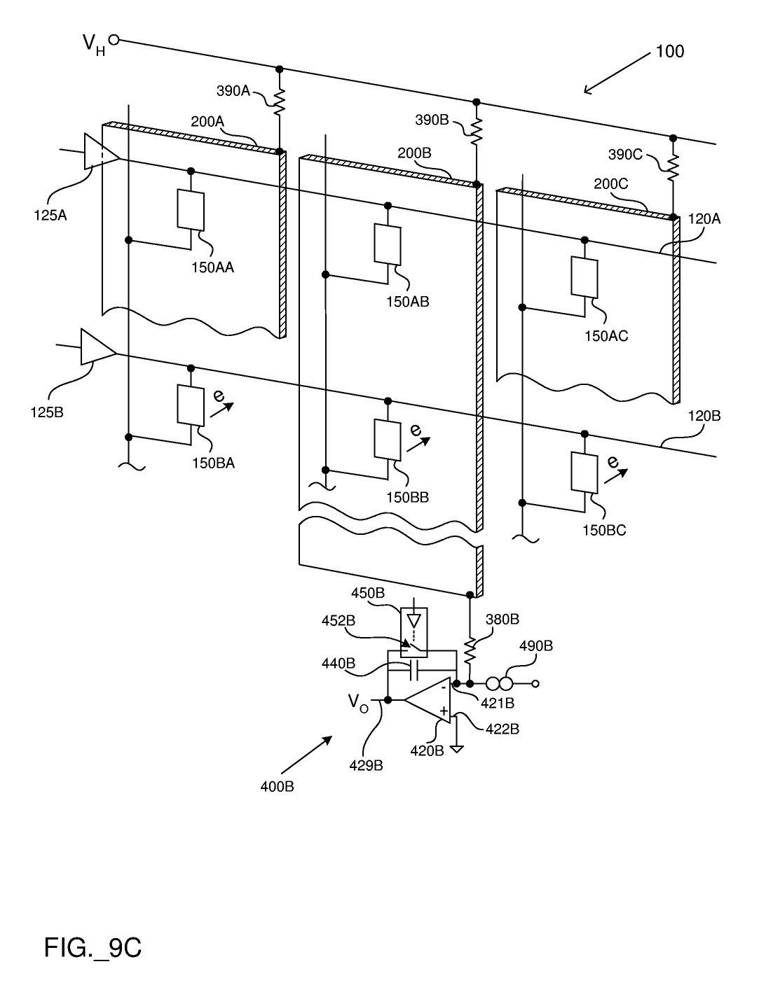

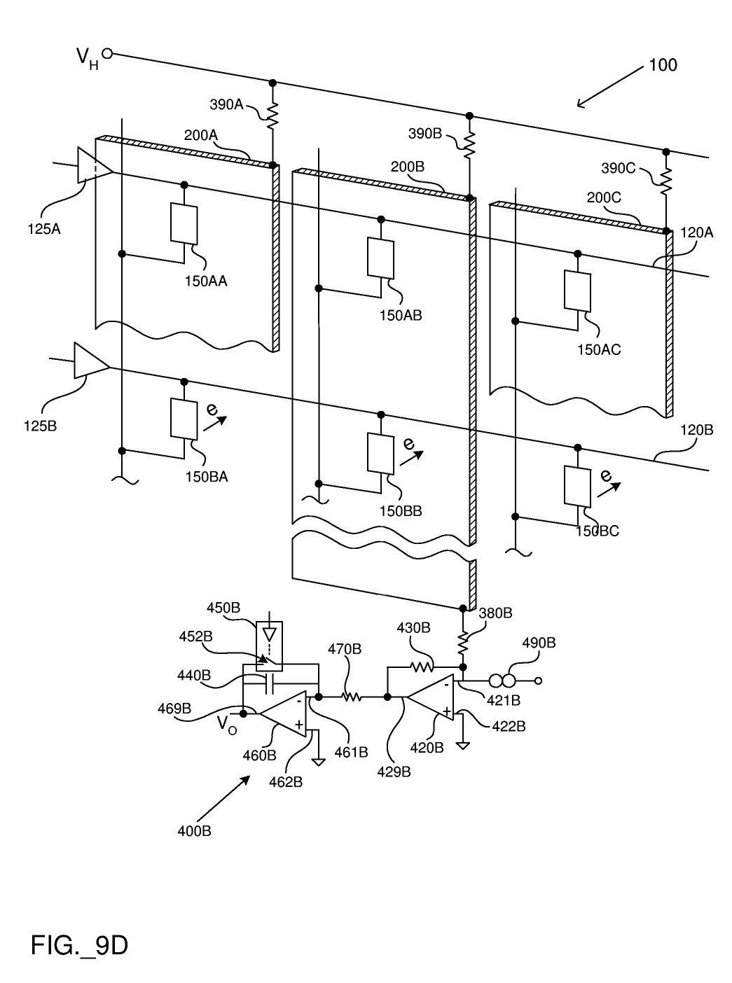

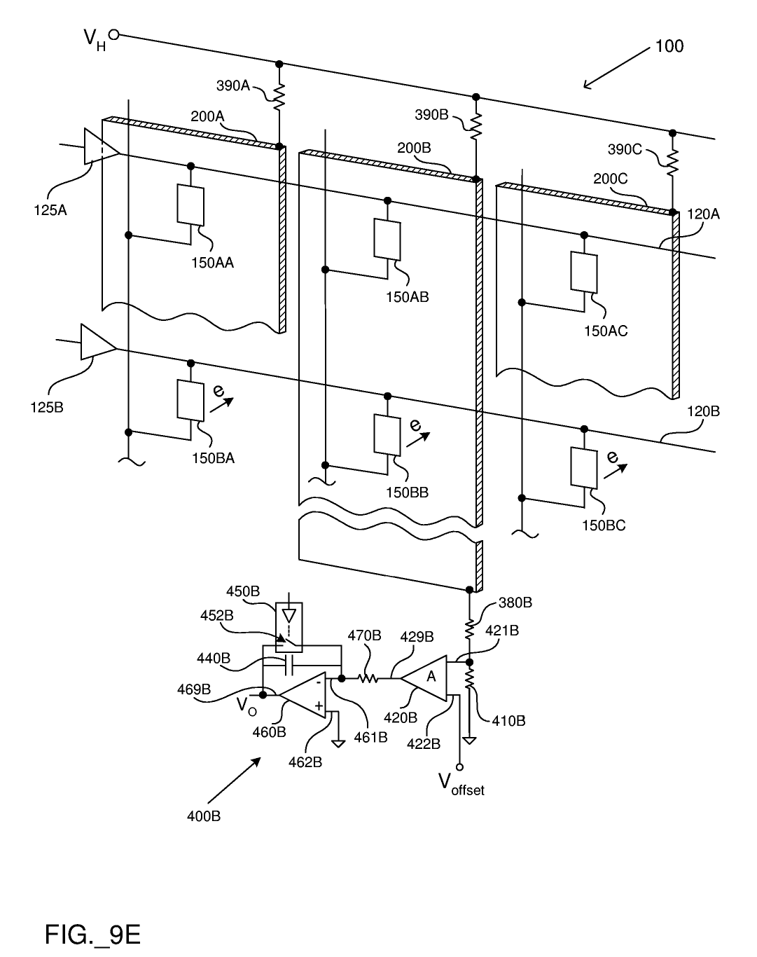

Previously, FIG. 4A and FIG. 4B illustrate two specific implementations of the monitoring devices (e.g., 400A, 400B, and 400C). In addition to these specific implementations, other implementations of the monitoring devices (e.g., 400A, 400B, and 400C) are possible. People skilled in the art can find other specific implementations that best serve their design needs or product specifications. FIG. 9A-FIG. 9E provides more exemplary implementations of the monitoring devices. In FIG. 9A-FIG. 9E, a monitoring device 400B is coupled to an anode 200B through a coupling resistor 380B. Anode 200B is connected to an anode voltage V_{II} through a load resistor 390B. The resistive value of coupling resistor 380B is R_{C}. The resistive value of load resistor 390B is R_{H}.

In the implementation as shown in FIG. 9A, a monitoring device 400B can include a sensing resistor 410B and an instrumentation amplifier 420B. The resistive value of sensing resistor 410B is R_{S}. Amplifier 420B includes a first input 421B, a second input 422B, and an output 429B. Instrumentation amplifier 420B is connected to sensing resistor 410B to measure a voltage V_{S} across the sensing resistor 410B. The voltage V_{S} across the sensing resistor (e.g., 410B) linearly depends upon the current Iₑ received by the anode (e.g., 200B) and follows the equation, V_{S}−[R_{S} R_{II}/(R_{II}+R_{C}+R_{S})]·Iₑ+[R_{S}/(R_{II}+R_{C}+R_{S})]·V_{II}.

In the implementation as shown in FIG. 9B, a monitoring device 400B can include a feedback resistor 430B and an amplifier 420B. The resistive value of the feedback resistor is R_{F}. Amplifier 420B includes a first input 421B, a second input 422B, and an output 429B. Feedback resistor 430B and amplifier 420B can form a current detector. The voltage Vₒ at the output of amplifier 420B is related to the current Iₛ passing through coupling resistor 380B. When first input 421B is connected to a current source 490B that provides an offset current I_{offset}, the voltage Vₒ at output 429B of amplifier 420B follows equation, Vₒ=−R_{F}·(Iₛ−I_{offset}). The current Iₛ passing through coupling resistor 380B is related to the current Iₑ received by anode 200B and follows equation, Iₛ=−[R_{H}/(R_{H}+R_{C})]·Iₑ+V_{H}/(R_{H}+R_{C}). Consequently, the voltage Vₒ at output 429B is linearly depend on the current Iₑ received by anode 200B, Vₒ=−[R_{F}R_{H}/(R_{H}+R_{C})]·Iₑ+R_{F}[I_{offset}−V_{H}/(R_{H}+R_{C})]. In one implementation, when the offset current I_{offset} is designed to be equal to V_{H}/(R_{H}+R_{C}), the voltage Vₒ at output 429B is proportional to the current Iₑ received by anode 200B, Vₒ=−[R_{F}R_{H}/(R_{H}+R_{C})]·Iₑ.

In the implementation as shown in FIG. 9C, a monitoring device 400B includes an integration capacitor 440B and an amplifier 420B. The capacitive value of the integration capacitor is C₁. Amplifier 420B includes a first input 421B, a second input 422B, and an output 429B. Integration capacitor 440B and amplifier 420B can form a charge detector. It can be shown that, When the offset current I_{offset} is design to be equal to V_{H}/(R_{H}+R_{C}), the voltage Vₒ at output 429B is proportional to the total charge Qₑ received by anode 200B, Vₒ=−[R_{H}/(R_{H}+R_{C})C₁]·Qₑ, where the total charge Qₑ received by anode 200B is a time integration or the current Iₑ received by the anode, that is, Qₑ=∫Iₑ(t)dt. Monitoring device 400B in FIG. 9C can include a reset circuit 450B to reset the charge on integration capacitor 440B to zero. The reset circuit 450B can be used to specify the beginning time for integrating the emission current Iₑ received by anode 200B. The beginning time of the time integration can be set at the instant that a switch 452B across integration capacitor 440B changes from a closing state to an opening state.

FIG. 9D shows another implementation of the monitoring device. In FIG. 9D, total charge Qₑ received by an anode can be measured by modifying the monitoring device as shown in FIG. 9B. For example, the voltage at output 429B of amplifier 420B can be integrated over time with an integrate circuit to obtain the total charge Qₑ received by anode 200B.

In FIG. 9D, the integration circuit includes an amplifier 460B, an integration capacitor 440B, an integration resistor 470B, and a reset circuit 450B. The capacitive value of integration capacitor 440B is C₁. The resistive value of integration resistor 470B is R₁. Amplifier 460B includes a first input 461B, a second input 462B, and an output 469B. Reset circuit 450B can be used to reset the charge on integration capacitor 440B to zero. Reset circuit 450B can also be used to specify the beginning time for integrating the emission current Iₑ received by anode 200B. It can be shown that, when the offset current I_{offset} is designed to be equal to V_{H}/(R_{H}+R_{C}), the voltage V_{Q} at output 469B of amplifier 460B is proportional to the total charge Qₑ received by anode 200B, V_{Q}=[1/R₁C₁]·[R_{F}R_{H}/(R_{H}+R_{C})]·Qₑ, where the total charge Qₑ received by anode 200B is a time integration or the current Iₑ received by the anode, that is, Qₑ=∫Iₑ(t)dt.

FIG. 9E shows another implementation of the monitoring device. In FIG. 9E, total charge Qₑ received by an anode can be measured by modifying the monitoring device as shown previously in FIG. 4B. For example, the voltage at output 429B of instrumentation amplifier 420B can be integrated over time with an integration circuit to obtain the total charge Qₑ received by anode 200B,

In FIG. 9E, the integration circuit includes an amplifier 460B, an integration capacitor 440B, an integration resistor 470B, and a reset circuit 450B. The capacitive value of integration capacitor 440B is C₁. The resistive value of integration resistor 470B is R₁. Amplifier 460B includes a first input 461B, a second input 462B, and an output 469B. Reset circuit 450B can be used to reset the charge on integration capacitor 440B to zero. Reset circuit 450B can also be used to specify the beginning time for integrating the emission current Iₑ received by anode 200B

In FIG. 9E, monitoring 400B device includes a sensing resistor 410B and an instrumentation amplifier 420B. The resistive value of the sensing resistor is R_{S}. Instrumentation amplifier 420B includes a first input 421B, a second input 422 B, and an output 429B. Instrumentation amplifier 420B can generate an voltage Vₒ at output 429B that is proportional to a difference between the voltage V₁ applied to first input 421B and the voltage V₂ applied to second input 422B, that is, Vₒ=A(V₁−V₂), where coefficient A is a proportional constant. It can be shown that, when voltage V₂ applied to second input 422B is connected to an offset voltage such that V₂=V_{offset}=[R_{S}/(R_{H}+R_{C}+R_{S})]·V_{H}, the voltage V_{Q} at output 469B of amplifier 460B is proportional to the total charge Qₑ received by anode 200B, that is, V_{Q}=[A/R₁C₁]·[R_{S}R_{II}/(R_{II}+R_{C}+R_{S})]·Qₑ, where the total charge Qₑ received by anode 200B is a time integration of the current Iₑ received by anode 200B, that is, Qₑ=∫Iₑ(t)dt.

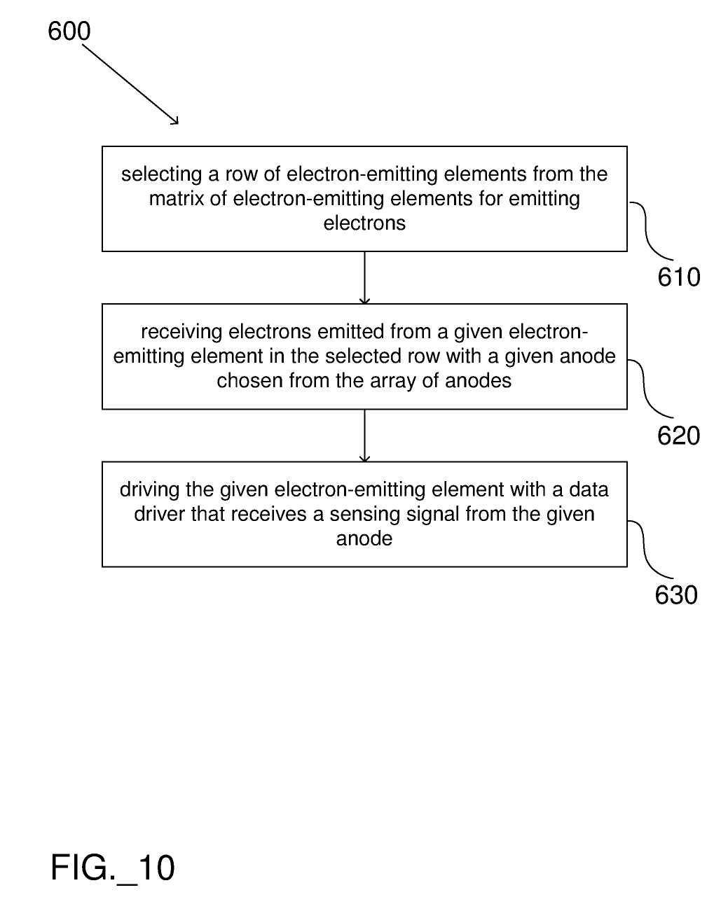

FIG. 10 shows a method 600 of driving a display device having a plurality of anodes. The display device includes a matrix of electron-emitting elements, an array of selection lines, an array of data driving lines crossing the array of selection lines, an array of anodes being substantially parallel to the array of data driving lines, and an enclosure configured to maintain substantially vacuum space between the matrix of the electron-emitting elements and the array of anodes. Method 600 includes steps 610, 620, and 630. Step 610 includes selecting a row of electron-emitting elements from the matrix of electron-emitting elements for emitting electrons. Step 620 includes receiving electrons emitted from a given electron-emitting element in the selected row with a given anode chosen from the array of anodes. Step 630 includes driving the given electron-emitting element with a data driver that receives a sensing signal from the given anode. The driving includes transmitting at least one data signal from the data driver to at least one data driving line that is electrically connected to the given electron-emitting element.

In one implementation, step 630 can include driving the given electron-emitting element with a data driver that compares a reference signal with a sensing signal from the given anode. In another implementation, step 630 can include driving the given electron-emitting element with a data driver that compares a reference signal with a sensing signal proportional to an electronic current received by the given anode. In still another implementation, step 630 can include driving the given electron-emitting element with a data driver that compares a reference signal with a sensing signal proportional to an amount of charges received by the given anode. Generally, in some implementations, a data driver can compare a reference signal with a sensing signal using a linear comparator, such as, a differential amplifier; in other implementations, a data driver can compare a reference signal with a sensing signal using a non-linear comparator, such as, a Schmitt trigger.

In one implementation, step 630 can include driving the given electron-emitting element in a negative feedback loop based on a feedback signal related to the sensing signal from the given anode. In another implementation, step 630 can include driving the given electron-emitting element in a negative feedback loop based on a feedback signal related to an electronic current received by the given anode. In still another implementation, step 630 can include driving the given electron-emitting element in a negative feedback loop based on a feedback signal related to an amount of charges received by the given anode.

As examples, when method 600 is used to drive a display device 100 as shown FIG. 6A-FIG. 6E and FIG. 7A-FIG. 7E, step 610 can include selecting a row of electron-emitting elements as formed by electron-emitting elements 150BA, 150BB, and 150BC. This row of electron-emitting elements can be selected by applying a selection signal (e.g., a selection voltage) to selection line 120B. The selection signal can be applied to selection line 120B using, for example, selection driver 125B.

In some implementations, selecting a row of electron-emitting elements includes selecting all electron-emitting elements in a given row of the matrix of the electron-emitting elements. In other implementations, selecting a row of electron-emitting elements includes selecting some (but not all) electron-emitting elements in a given row of the matrix of the electron-emitting elements.

As examples, when method 600 is used to drive a display device 100 as shown in FIG. 6A-FIG. 6E and FIG. 7A-FIG. 7E, step 620 can include receiving electrons emitted from a given electron-emitting element (e.g., 150BB) in the selected row with a given anode (e.g., 200B) chosen from the array of anodes. As other examples, step 620 can include receiving electrons emitted from electron-emitting element 150BA with anode 200A and receiving electrons emitted from electron-emitting element 150BC with anode 200C.

As examples, when method 600 is used to drive a display device 100 as shown in FIG. 6A-FIG. 6E and FIG. 7A-FIG. 7E, step 630 can include driving the given electron-emitting element (e.g., 150BB) with a data driver (e.g., 500B) that receives a sensing signal from the given anode (e.g., 200B).

Electron-emitting element 150BB can be driven with a data driver (e.g., 500B) that compares a reference signal with a sensing signal from the given anode (e.g., 200B). In some implementations, the sensing signal can be proportional to an electronic current received by the given anode (e.g., 200B). In other implementations, the sensing signal can be proportional to an amount of charges received by the given anode (e.g., 200B).

As examples, electron-emitting element 150BB can be driven in a negative feedback loop that includes a data driver 500B. Data driver 500B can receive a feedback signal from monitoring device 400B. In some implementations, monitoring device 400B can be used to measure the electronic current received by anode 200B from electron-emitting element 150BB. In some implementations, monitoring device 400B can be used to measure the amount of charges received by anode 200B from electron-emitting element 150BB. In some implementations, the feedback signal can be related to the electronic current received by the given anode (e.g., 200B). In other implementations, the feedback signal can be related to the amount of charges received by the given anode (e.g., 200B). Certainly, the amount of charges received by a given anode is related to the electronic current received by the given anode. More specifically, the amount of charges received by a given anode can be a time integration of the electronic current received by the given anode. The time integration of the electronic current can be performed with various kinds of electronic circuits including analog electronic circuits, digital electronic circuits, or a combination of analog electronic circuits and digital electronic circuits. The time integration of the electronic current can be performed with a data driver (e.g., 500A, 500B, or 500C). The time integration of the electronic current can also be performed with a monitoring device (e.g., 400A, 400B, or 400C).

The method of driving a display device in feedback loops may have the advantage to compensate variations of the emission properties of the electron-emitting elements in the display device. This method may have the advantage to compensate degradation or changes in the emission properties of the electron-emitting elements in the display device. The negative feedback loops can be an analog control loop, a digital control loop, or a combination of an analog and a digital control loop. The negative feedback loop can be a proportional control loop, a proportional integration control loop, a proportional differential control loop, a proportional differential integration control loop, or a nonlinear control loop. In some implementations, the negative feedback loop can be a bang-bang control loop.

In some implementations, when method 600 is used to drive a display device 100 as shown in FIG. 6A-FIG. 6E and FIG. 7A-FIG. 7E, method 600 can include measuring an electronic current emitted to the given anode (e.g., 200B) from the given electron-emitting element (e.g., 150BB). When a row of electron-emitting elements (e.g., the row formed by electron-emitting elements 150BA, 150BB, and 150BC) is selected, the electronic current emitted by an electron-emitting element in the selected row can be measured. The electronic current emitted to a given anode from a given electron-emitting element can be measured with a monitoring device. For example, the electronic current emitted to anode 200A from electron-emitting element 150BA can be measured with monitoring device 400A, the electronic current emitted to anode 200B from electron-emitting element 150BB can be measured with monitoring device 400B, and the electronic current emitted to anode 200C from electron-emitting element 150BC can be measured with monitoring device 400C.

In some implementations, the electronic current emitted to a given anode (e.g., 200B) can be measured by measuring a voltage across a sensing resistor (e.g., 410B). In other implementations, the electronic current emitted to a given anode can be measured with other kinds of current detectors.

In some implementations, when method 600 is used to drive a display device 100 as shown in FIG. 6A-FIG. 6E and FIG. 7A-FIG. 7E, method 600 can include measuring an amount of charge emitted to the given anode (e.g., 200B) from the given electron-emitting element (e.g., 150BB). When a row of electron-emitting elements (e.g., the row formed by electron-emitting elements 150BA, 150BB, and 150BC) is selected, the amount of charge emitted by an electron-emitting element in the selected row can be measured. The amount of charge emitted to a given anode (e.g., 200B) from a given electron-emitting element (e.g., 150BB) can be measured with a monitoring device directly. The amount of charge emitted to a given anode (e.g., 200B) from a given electron-emitting element (e.g., 150BB) can also be measured by integrate over time an electric current emitted to the given anode (e.g., 200B) from the given electron-emitting element (e.g., 150BB).

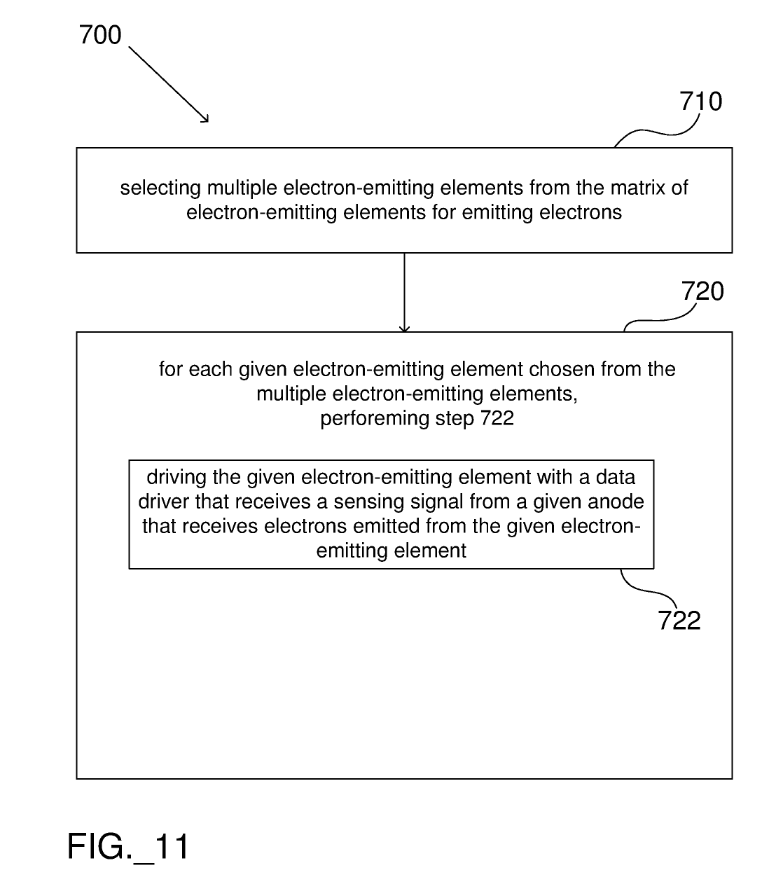

FIG. 11 shows a method 700 of driving a display device having a plurality of anodes. The display device includes a matrix of electron-emitting elements, an array of selection lines, an array of data driving lines crossing the array of selection lines, an array of anodes being substantially parallel to the array of data driving lines, and an enclosure configured to maintain substantially vacuum space between the matrix of the electron-emitting elements and the array of anodes. Method 700 includes steps 710 and 720. Step 710 includes selecting multiple electron-emitting elements from the matrix of electron-emitting elements for emitting electrons. Step 720 includes, for each given electron-emitting element chosen from the multiple electron-emitting elements, performing step 722. Step 722 includes driving the given electron-emitting element with a data driver that receives a sensing signal from a given anode that receives electrons emitted from the given electron-emitting element. The driving includes transmitting at least one data signal from the data driver to at least one data driving line that is electrically connected to the given electron-emitting element.

In one implementation, step 722 can include driving the given electron-emitting element with a data driver that compares a reference signal with a sensing signal from the given anode. In another implementation, step 722 can include driving the given electron-emitting element with a data driver that compares a reference signal with a sensing signal proportional to an electronic current received by the given anode. In still another implementation, step 722 can include driving the given electron-emitting element with a data driver that compares a reference signal with a sensing signal proportional to an amount of charges received by the given anode. Generally, in some implementations, a data driver can compare a reference signal with a sensing signal using a linear comparator, such as, a differential amplifier; in other implementations, a data driver can compare a reference signal with a sensing signal using a non-linear comparator, such as, a Schmitt trigger.

In one implementation, step 722 can include driving the given electron-emitting element in a negative feedback loop based on a feedback signal from the given anode. In another implementation, step 722 can include driving the given electron-emitting element in a negative feedback loop based on a feedback signal related to an electronic current emitted to the given anode from the given electron-emitting element. In still another implementation, step 722 can include driving the given electron-emitting element in a negative feedback loop based on a feedback signal related to an amount of charges emitted to the given anode from the given electron-emitting element.

As examples, when method 700 is used to drive a display device 100 as shown in FIG. 6A-FIG. 6E and FIG. 7A-FIG. 7E, step 710 can include selecting multiple electron-emitting elements, such as a row of electron-emitting elements formed by electron-emitting elements 150BA, 150BB, and 150BC. In some implementations, the selected multiple electron-emitting elements forms a row that includes all of the electron-emitting elements in a given row of the matrix of electron-emitting elements. In other implementations, the selected multiple electron-emitting elements forms a row that includes some of the electron-emitting elements in a given row of the matrix of electron-emitting elements.

As examples, in FIG. 6A-FIG. 6E and FIG. 7A-FIG. 7E, when the selected multiple electron-emitting elements includes electron-emitting elements 150BA, 150BB, and 150BC, step 720 includes performing step 722 for each given electron-emitting element chosen from the multiple electron-emitting elements. In some implementations of step 720, step 722 is performed for all of the selected multiple electron-emitting elements (for example, performed for electron-emitting elements 150BA, 150BB, and 150BC). In other implementations of step 720, step 722 is performed for some of the selected multiple electron-emitting elements (for example, performed for electron-emitting elements 150BA and 150BB but not for electron-emitting element 150BC).

As examples, in FIG. 6A-FIG. 6E and FIG. 7A-FIG. 7E, when step 722 is performed for electron-emitting element 150BB, step 722 includes driving electron-emitting element 150BB with a data driver 500B that receives a sensing signal from a given anode that receives electrons emitted from electron-emitting element 150BB. In one example, the anode that receives electrons emitted from electron-emitting element 150BB is anode 200B. In some implementations, an anode in the array of anodes can be designed to receive electrons from one column of electron-emitting elements. In other implementations, a given an anode in the array of anodes can be designed to receive electrons from multiple columns of electron-emitting elements (e.g., two columns or three columns).

When step 722 is performed for electron-emitting element 150BB, electron-emitting element 150BB can be driven with the corresponding electronic circuit as shown in FIG. 6A-FIG. 6E and FIG. 7A-FIG. 7E, electron-emitting element 150BB can also be driven with some variations of the corresponding electronic circuit as shown in FIG. 7A-FIG. 7C. People skilled in the art can also design other circuits for driving electron-emitting element 150BB with a data driver that receives a sensing signal from anode 200B.

As examples, in FIG. 6A-FIG. 6E and FIG. 7A-FIG. 7E, when step 722 is performed for electron-emitting element 150BB, step 722 can include driving electron-emitting element 150BB with a data driver 500B that compares a reference signal with a sensing signal from anode 200B. In another implementation, step 722 can include driving electron-emitting element 150BB with a data driver 500B that compares a reference signal with a sensing signal proportional to an electronic current received by anode 200B. In still another implementation, step 722 can include driving electron-emitting element 150BB with a data driver 500B that compares a reference signal with a sensing signal proportional to an amount of charges received by anode 200B.

As examples, in FIG. 6A-FIG. 6E and FIG. 7A-FIG. 7E, when step 722 is performed for electron-emitting element 150BB, step 722 can include driving electron-emitting element 150BB in a negative feedback loop based on a feedback signal from the given anode 200B. In another implementation, step 722 can include driving electron-emitting element 150BB in a negative feedback loop based on a feedback signal related to an electronic current emitted to the given anode 200B from electron-emitting element 150BB. For example, the feedback signal can be proportional to the electronic current emitted to the given anode 200B from electron-emitting element 150BB. In still another implementation, step 722 can include driving electron-emitting element 150BB in a negative feedback loop based on a feedback signal related to an amount of charges emitted to the given anode 200B from electron-emitting element 150BB. For example, the feedback signal can be proportorial to the amount of charges received by anode 200B.

When electron-emitting element 150BB is driven in a negative feedback loop, the negative feedback loops can be an analog control loop, a digital control loop, or a combination of an analog and a digital control loop. The negative feedback loop can be a proportional control loop, a proportional integration control loop, a proportional differential control loop, a proportional differential integration control loop, or a nonlinear control loop. In some implementations, the negative feedback loop can be a bang-bang control loop.

In some implementations, after step 710 in which multiple electron-emitting elements are selected, step 720 can include a measuring step for each given electron-emitting element chosen from the multiple electron-emitting elements. In one implementation, the measuring step can include measuring an electronic current emitted to an anode from the given electron-emitting element. In another implementation, the measuring step can include measuring an amount of charges emitted to an anode from the given electron-emitting element.

As examples, in FIG. 5A-FIG. 5E, when the measuring step is performed on electron-emitting element 150BB, method 700 can include measuring an electronic current emitted to anode 200B from electron-emitting element 150BB. The electronic current emitted to anode 200B from electron-emitting element 150BB can be measured with monitoring device 400B. The electronic current emitted to anode 200B from electron-emitting element 150BB can also be measured with some variations of monitoring device 400B. People skilled in the art can also design other methods for measuring the electronic current emitted to anode 200B from electron-emitting element 150BB.

As examples, in FIG. 5A-FIG. 5E, when the measuring step is performed on electron-emitting element 150BB, method 700 can include measuring an amount of charges emitted to anode 200B from electron-emitting element 150BB. The amount of charges emitted to anode 200B from electron-emitting element 150BB can be measured with monitoring device 400B. The amount of charges emitted to anode 200B from electron-emitting element 150BB can also be measured with some variations of monitoring device 400B. People skilled in the art can also design other methods for measuring the amount of charges emitted to anode 200B from electron-emitting element 150BB.

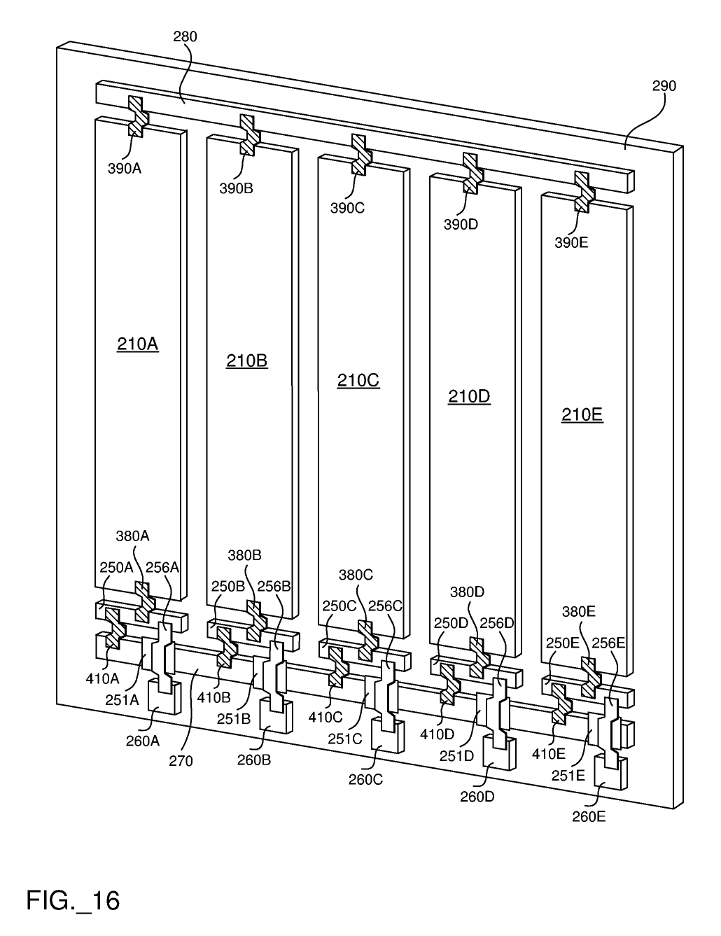

FIG. 16 shows an implementation of a faceplate structure that can be used to construct a display device as described herein. The faceplate structure includes a substantially transparent plate 290, an array of conducting sheets (e.g., 210A, 210B, 210C, 210D, and 210E), a biasing conducting electrode 280, an array of load resistors (e.g., 390A, 390B, 390C, 390D, and 390E), an array of contacting electrodes (e.g., 250A, 250B, 250C, 250D, and 250E), and an array of coupling resistors (e.g., 380A, 380B, 380C, 380D, and 380E). The array of conducting sheets, the biasing conducting electrode, the array of contacting electrodes are deposited on substantially transparent plate 290. A conducting sheet (e.g., 210B) has phosphors deposited thereon. A load resistor (e.g., 390B) forms a resistively conducting path between a conducting sheet (e.g., 210B) and the biasing conducting electrode (i.e. 280). A coupling resistor (e.g., 380B) forms a resistively conducting path between a conducting sheet (e.g., 210B) and a contacting electrode (e.g., 250B). The load resistors can be thin film resistors. The coupling resistors can also be thin film resistors.

The faceplate structure can also include a common conducting electrode 270, and an array of sensing resistors (e.g., 410A, 410B, 410C, 410D, and 410E). Common conducting electrode 270 is deposited on substantially transparent plate 290. A sensing resistor (e.g., 410B) forms a resistively conducting path between a contacting electrode (e.g., 250B) and the common conducting electrode (i.e. 270). The sensing resistors can be thin film resistors.

The faceplate structure can also include an array of interfacing electrodes (e.g., 260A, 260B, 260C, 260D, and 260E). An interfacing electrode (e.g., 260B) can be connected to a contacting electrode (e.g., 250B) with a conducting member (e.g., 256B). An insulation material (e.g., 251B) can be used between the common conducting electrode (i.e. 270) and a conducting member (e.g., 256B) to avoid any unwanted electrical contacts. In some implementations, the array of interfacing electrodes can be configured for Tape Automated Bonding (TAB).

In operation, the biasing conducting electrode (i.e. 280) in the faceplate structure can be connected to an anode voltage. The contacting electrodes or the interfacing electrodes can provide signals that can be transmitted to monitoring devices (e.g., 400A, 400B, and 400C) or data drivers (e.g., 500A, 500B, and 500C) as previously described. The faceplate structure in FIG. 16 may have some desirable properties. For example, even the biasing conducting electrode is biased at a quite high voltage (e.g., 500V), the contacting electrodes or the interfacing electrodes may still be able to provide low voltage output signals for transmitting to monitoring devices or data drivers.

While the implementation of the faceplate structure in FIG. 16 includes an array of coupling resistors, other implementations of the faceplate structure can include an array of coupling capacitors. In one implementation, the faceplate structure includes a substantially transparent plate 290, an array of conducting sheets (e.g., 210A, 110B, 210C, 210D, and 210E), a biasing conducting electrode 280, an array of load resistors (e.g., 390A, 390B, 390C, 390D, and 390E), an array of contacting electrodes (e.g., 250A, 250B, 250C, 250D, and 250E), and an array of coupling capacitors (e.g., 370A, 370B, 370C, 370D, and 370E). The array of conducting sheets, the biasing conducting electrode, the array of contacting electrodes are deposited on substantially transparent plate 290. A conducting sheet (e.g., 210B) has phosphors deposited thereon. A load resistor (e.g., 390B) forms a resistively conducting path between a conducting sheet (e.g., 210B) and the biasing conducting electrode (i.e. 280). A coupling capacitor (e.g., 370B) forms a capacitively conducting path between a conducting sheet (e.g., 210B) and a contacting electrode (e.g., 250B). The load resistors can be thin film resistors.

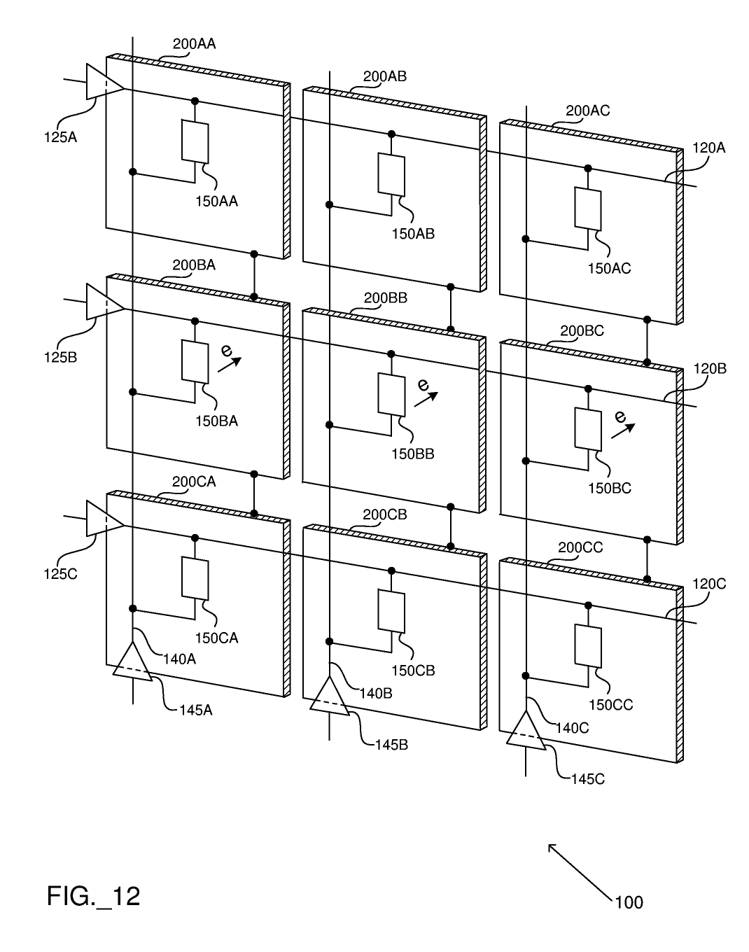

A display device as described herein includes an array of anodes. The anode in the array of anodes can be constructed from a single conducting plate. The anode in the array of anodes can also be constructed in other ways. For example, the anode in the array of anodes can include multiple anode segments. More specifically, as shown in FIG. 12, an anode (e.g., 200B) in the array of anodes can include a column of electrically connected anode segments (e.g., 200BA, 200BB, and 200BC).

A display device having multiple anodes can be constructed in such a way to drive electron-emitting elements with control circuits. Driving electron-emitting elements with control circuits may improve the display quality of the display device. A display device having multiple anodes can also be constructed in such a way to speed up the calibration process on a display device. When a display device includes a single anode that is connected to a monitoring device, it can be very time consuming to measure the properties of electron-emitting elements in a big matrix. When a display device includes an array of anodes, the properties of many electron-emitting elements can be measured simultaneously. For example, each of these electron-emitting elements in a row of matrix can be measured with a corresponding monitoring device connected to one of the multiple anodes.

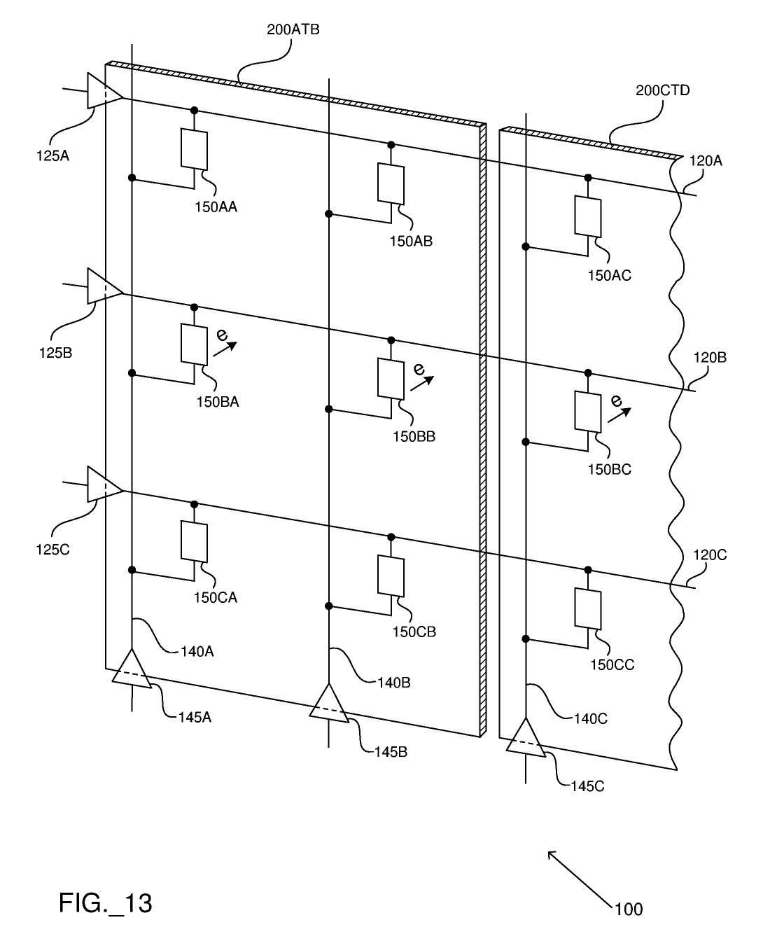

In some implementations of the display device, an anode in an array of anodes is configured to receive electrons from a corresponding column of electron-emitting elements chosen from the matrix of electron-emitting elements. In other implementations of the display device, an anode in an array of anodes is configured to receive electrons from multiple corresponding columns of electron-emitting elements chosen from the matrix of electron-emitting elements. For example, as shown in FIG. 13, an anode 200ATB can be configured to receive electrons from a first column of electron-emitting elements (formed by electron-emitting elements 150AA, 150BA, and 150CA) and a second column of electron-emitting elements (formed by electron-emitting elements 150AB, 150BB, and 150CB). Similarly, an anode 200CTD can be configured to receive electrons from a first column of electron-emitting elements (formed by electron-emitting elements 150AC, 150BC, and 150CC) and a second column of electron-emitting elements (formed by electron-emitting elements 150AD, 150BD, and 150CD, which are not shown in the figure). In FIG. 13, symbol ATB is chosen to take the meaning of A to B, and symbol CTD is chosen to take the meaning of C to D.

When a given anode is associated with multiple corresponding columns of electron-emitting elements, a monitoring device connected to the given anode can be configured to measure the current emitted by any one electron-emitting element among the electron-emitting elements in the multiple corresponding columns.

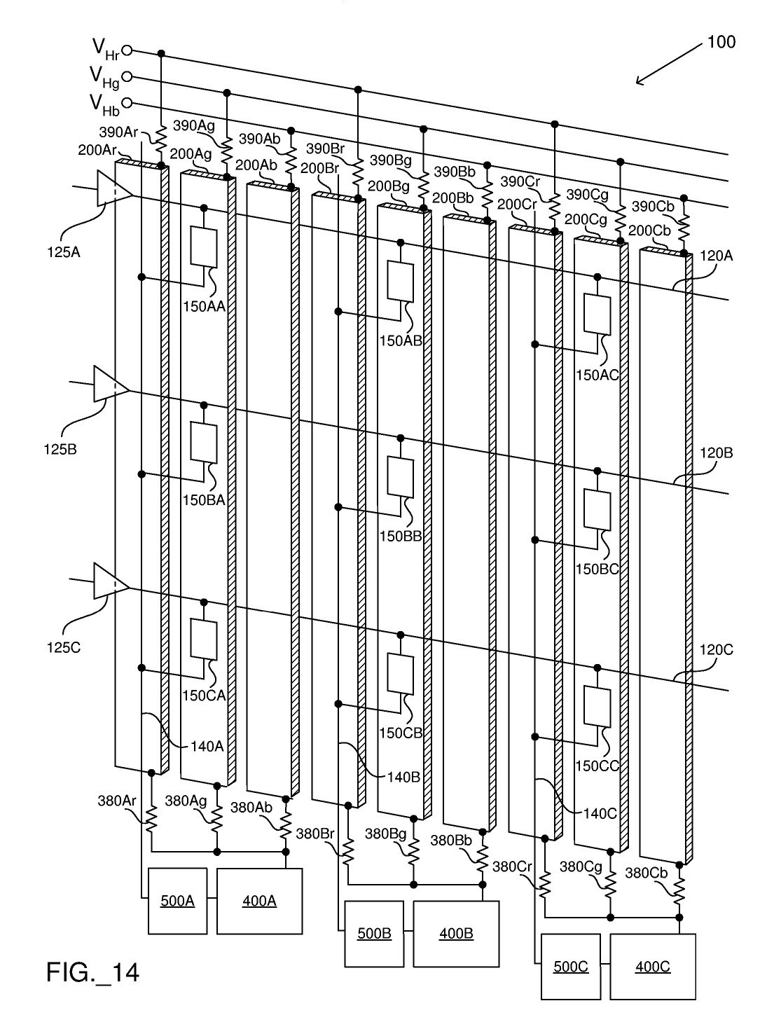

In some implementations of the display device, a column of electron-emitting elements can be configured to emit electrons to a corresponding anode in the array of anodes. In other implementations, a column of electron-emitting elements can be configured to emit electrons to multiple corresponding anodes in the array of anodes. For example, as shown in FIG. 14, a column of electron-emitting elements (e.g., electron-emitting elements 150AB, 150BB, and 150BC) can be configured to emit electrons to multiple corresponding anodes (e.g., anodes 200Br, 200Bg, and 200Bb).

In the implementation as shown in FIG. 14, first type anodes (e.g., 200Ar, 200Br, and 200Cr) are coated with red phosphors, second type anodes (e.g., 200Ag, 200Bg, and 200Cg) are coated with green phosphors, and third type anodes (e.g., 200Ab, 200Bb, and 200Cb) are coated with blue phosphors. The first type anodes (e.g., 200Ar, 200Br, and 200Cr) are connected to a first anode voltage V_{H} r, the second type anodes (e.g., 200Ag, 200Bg, and 200Cg) are connected to a second anode voltage V_{Hg}, the third type anodes (e.g., 200Ab, 200Bb, and 200Cb) are connected to a third anode voltage V_{IIb}.

In operation, when each of the anode voltages V_{Hr}, V_{Hg}, and V_{Hb} is sequentially set to a high voltage, electrons emitted from electron-emitting elements will sequentially strike first type anodes with red phosphors, second type anodes with green phosphors, and third type anodes with blue phosphors. A monitoring device (e.g., 400B) can be used to measure the electrons received by a corresponding first type anode (e.g., 200Br), the electrons received by a corresponding second type anode (e.g., 200Bg), or the electrons received by a corresponding third type anode (e.g., 200Bb). In some implementations, a data driver (e.g., 500B) can be configured to control the current received by a corresponding first type anode (e.g., 200Br), the current received by a corresponding second type anode (e.g., 200Bg), or the current received by a corresponding third type anode (e.g., 200Bb). In other implementations, a data driver (e.g., 500B) can be configured to control the amount of charges received by a corresponding first type anode (e.g., 200Br), the amount of charges received by a corresponding second type anode (e.g., 200Bg), or the amount of charges received by a corresponding third type anode (e.g., 200Bb).

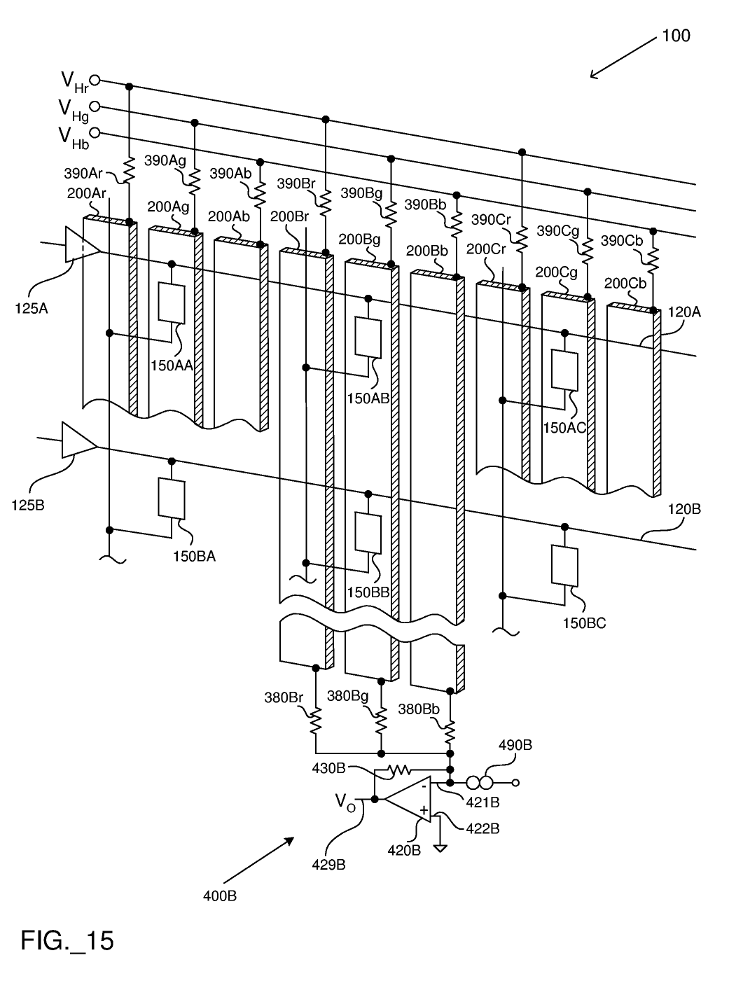

FIG. 15 shows an implementation of a monitoring device that is associated with multiple corresponding anodes. In FIG. 15, monitoring device 400B can be used to measure the electrons received by anodes 200Br, 200Bg, or 200Bb. Monitoring device 400B is electrically connected to anodes 200Br, 200Bg, and 200Bb through coupling resistors 380Br, 380Bg, and 380Bb, respectively. In one implementation, when only one of the three anodes (i.e., 200Br, 200Bg, and 200Bb) receives substantially amount of electrons at a particular moment, the output voltage Vₒ of monitoring device 400B can provide a direct measurement of the current received by that anode at that particular moment.

In some implementations of the display device, a data driver is associated with a corresponding column of electron-emitting elements. In other implementations, a data driver can be associated with multiple corresponding columns of electron-emitting elements. For example, a data driver can be associated with multiple corresponding columns of electron-emitting elements using multiplexing circuits.

In some implementations of the display device, an electron-emitting element in the display device as described herein can be connected to a corresponding selection line and a corresponding data driving line. In other implementations, an electron-emitting element in the display device as described herein can be connected to multiple corresponding selection lines. In still other implementations, an electron-emitting element in the display device as described herein can be connected to multiple corresponding data driving lines.

In general, depending upon the specific technologies employed, the display device described herein can be characterized by different names, such as, filed emission displays (FED), thin CRT displays, nano-tube displays, or Surface-conduction Emission Display (SED) as used by Canon.

The present invention has been described in terms of a number of implementations. The invention, however, is not limited to the implementations depicted and described. Rather, the scope of the invention is defined by the appended claims. For example, when an element A is electrically connected to an element B, generally, the element A can be physically connected to the element B directly, or the element A can be physically connected to the element B through one or more intermediate electronic elements. Any element in a claim that does not explicitly state “means for” performing a specific function, or “step for” performing a specific function, is not to be interpreted as a “means” or “step” clause as specified in 35 U.S.C. §112, ¶6.

What is claimed is:

1. A faceplate for using in a filed emission display device, comprising:
a substantially transparent plate;
an array of conducting sheets on the substantially transparent plate, wherein a conducting sheet has phosphors thereon;
a biasing conducting electrode on the substantially transparent plate;
an array of load resistors on the substantially transparent plate, wherein a load resistor is electrically connected between the biasing conducting electrode and one conducting sheet;
an array of contacting electrodes on the substantially transparent plate; and
an array of coupling elements on the substantially transparent plate, wherein a coupling element is electrically connected between one contacting electrode and one conducting sheet.

2. The faceplate of claim 1, further comprising:
an array of interfacing electrodes on the substantially transparent plate, and wherein an interfacing electrode and a contacting electrode is electrically connected.

3. The faceplate of claim 1, further comprising:
an array of interfacing electrodes on the substantially transparent plate and configured for Tape Automated Bonding, and wherein an interfacing electrode and a contacting electrode is electrically connected.

4. The faceplate of claim 1, wherein a conducting sheet comprises a plurality of conducting segments.

5. The faceplate of claim 1, wherein a coupling element comprises a coupling resistor.

6. The faceplate of claim 1, wherein a coupling element comprises a coupling capacitor.

7. The faceplate of claim 1, wherein a coupling element comprises a combination including at least one coupling resistor and at least one coupling capacitor.

8. A faceplate for using in a filed emission display device, comprising:
a substantially transparent plate;
an array of conducting sheets on the substantially transparent plate, wherein a conducting sheet has phosphors thereon;
a biasing conducting electrode on the substantially transparent plate;
an array of load resistors on the substantially transparent plate, wherein a load resistor is electrically connected between the biasing conducting electrode and one conducting sheet;
an array of contacting electrodes on the substantially transparent plate;
an array of coupling elements on the substantially transparent plate, wherein a coupling element is electrically connected between one contacting electrode and one conducting sheet;
a common conducting electrode on the substantially transparent plate; and
an array of sensing elements on the substantially transparent plate, wherein a sensing element is electrically connected between one contacting electrode and the common conducting electrode.

9. The faceplate of claim 8, further comprising:
an array of interfacing electrodes on the substantially transparent plate, and wherein an interfacing electrode and a contacting electrode is electrically connected.

10. The faceplate of claim 8, further comprising:
an array of interfacing electrodes on the substantially transparent plate and configured for Tape Automated Bonding, and wherein an interfacing electrode and a contacting electrode is electrically connected.

11. The faceplate of claim 8, wherein a sensing element comprises a sensing resistor.

12. The faceplate of claim 8, wherein a sensing element comprises a sensing capacitor.

13. The faceplate of claim 8, wherein a sensing element comprises a combination including at least one sensing resistor and at least one sensing capacitor.

14. A faceplate for using in a filed emission display device, comprising:
a substantially transparent plate;
an array of conducting sheets on the substantially transparent plate, wherein a conducting sheet has phosphors thereon;
a biasing conducting electrode on the substantially transparent plate;
an array of resistors on the substantially transparent plate, wherein a resistor is electrically connected between the biasing conducting electrode and one conducting sheet; and
an array of interfacing electrodes on the substantially transparent plate, and wherein an interfacing electrode and a conducting sheet is electrically connected.

15. The faceplate of claim 14, wherein the array of interfacing electrodes is configured for Tape Automated Bonding,

16. A method of driving a display device,
the display device includes a matrix of electron-emitting elements, an array of selection lines, an array of data driving lines crossing the array of selection lines, an array of anodes being substantially parallel to the array of data driving lines, and an enclosure configured to maintain substantially vacuum space between the matrix of the electron-emitting elements and the array of anodes,
the method comprising:
selecting multiple electron-emitting elements from the matrix of electron-emitting elements for emitting electrons; and
for each given electron-emitting element chosen from the multiple electron-emitting elements,
driving the given electron-emitting element with at least one data signal that depends upon a sensing signal from a given anode that receives electrons emitted from the given electron-emitting element, wherein the receiving of electrons by the given anode affects the sensing signal.

17. The method of claim 14, wherein the driving comprises:
driving the given electron-emitting element with a data driver that compares a reference signal with a sensing signal from the given anode.

18. The method of claim 14, wherein the driving comprises:
driving the given electron-emitting element with a data driver that compares a reference signal with a sensing signal proportional to an electronic current received by the given anode.

19. The method of claim 14, wherein the driving comprises:
driving the given electron-emitting element with a data driver that compares a reference signal with a sensing signal proportional to an amount of charges received by the given anode.

20. The method of claim 14, wherein the driving comprises:
driving the given electron-emitting element in a negative feedback loop base on a feedback signal related to the sensing signal from the given anode.

21. The method of claim 14, wherein the driving comprises:
driving the given electron-emitting element in a negative feedback loop base on a feedback signal related to an electronic current emitted to the given anode from the given electron-emitting element.

22. The method of claim 14, wherein the driving comprises:
driving the given electron-emitting element in a negative feedback loop base on a feedback signal related to an amount of charges emitted to the given anode from the given electron-emitting element.
